(19) United States
(12) Patent Application Publication
(10) Pub. No.: US 2014/0031103 A1
(43) Pub. Date: Jan. 30, 2014

(54) STORAGE MEDIUM, GAME APPARATUS, GAME CONTROLLING METHOD AND GAME SYSTEM

(71) Applicant: NINTENDO CO., LTD., Kyoto (JP)

(72) Inventors: Yusuke AMANO, Kyoto (JP); Ryuhei MATSUURA, Kyoto (JP)

(73) Assignee: NINTENDO CO., LTD., Kyoto (JP)

(21) Appl. No.: 13/749,086

(22) Filed: Jan. 24, 2013

(30) Foreign Application Priority Data
Jul. 26, 2012 (JP) 2012-166404

(51) Int. Cl. A63F 13/10

(52) U.S. Cl. CPC A63F 13/10
USPC 463/23

(57) ABSTRACT

An example non-limiting game apparatus includes a stereoscopic LDC on which an image of a displaying range that is a part of a course provided in a virtual game space is displayed as a game screen. With respect to the displaying range, a movable range obtained by analogously enlarging the displaying range is set, and each of a plurality of player objects moves within the movable range according to an operation by each player. When a time period that the player object exists outside the displaying range reaches a predetermined time period or when the player object is going to go out of the movable range, the player object is forcedly moved into the displaying range. At this time, the player object is brought into a defensive state that the player object is not affected at least with an attack by an enemy object.

### CROSS REFERENCE OF RELATED APPLICATION

The disclosure of Japanese Patent Application No. 2012-166404 filed on Jul. 26, 2012 is incorporated by reference.

### FIELD

This application describes a storage medium, a game apparatus, a game controlling method and a game system, for displaying an object in a virtual space.

### SUMMARY

It is a primary object of embodiments to provide a novel storage medium, game apparatus, game controlling method and game system.

Furthermore, it is another object of the embodiments to provide a storage medium, game apparatus, game controlling method and game system, capable of enjoying the same game together even if players have different abilities.

A first embodiment is a non-transitory computer readable storage medium storing a game program which is executable by a computer of a game apparatus in which each of a plurality of player objects moves within a first range in a virtual space according to an operation by each of a plurality of players, and a game screen based on a second range that is at least a part of the first range is displayed. The game program causes the computer to function as an operation receiving portion, an object controlling portion, a changing portion, a defensive object moving portion and a returning portion. The operation receiving portion receives operating inputs from the plurality of players. The object controlling portion moves respective player objects each assigned to each of the plurality of players within the first range in accordance with the operating inputs received by the operation receiving portion. The changing portion changes, when a player object moved in accordance with an operating input by a player out of the plurality of players moves out of the second range, the player object into a defensive state defending the player object against an attack from an enemy object. The defensive object moving portion moves the player object changed to the defensive state within at least the second range. The returning portion returns the player object changed to the defensive state to a state being not defended.

According to the first embodiment, since the player object which went out of the second range is moved within the second range in the defensive state, and thereafter, the object is returned to the state not being defended, it is possible to safely move the player object having been out of the second range due to the delay thereof so as to catch up another player object. Accordingly, it is possible to enjoy the same game together even if the players have different abilities.

A second embodiment is according to the first embodiment, wherein the changing portion changes, if and when a time period that the player object exists outside the second range reaches a predetermined time period, the player object into the defensive state. That is, a time period that the player object exists outside the second range is restricted.

According to the second embodiment, since a time period that the player object exists outside the second range is restricted, it is possible to restrict a time period that the player object is operated in a state that the player object is invisible as existing outside the second range.

A third embodiment is according to the first embodiment, wherein the first range is a predetermined range that the player object is movable, and the second range is a displaying range narrower than the predetermined range.

According to the third embodiment, since the player object can be moved in the predetermined range broader than the displaying range, even if a less-skilled player cannot follow a high-skilled player, it is possible for the less-skilled player to operate own player object with ease.

A fourth embodiment is according to the third embodiment, wherein the changing portion changes, if and when the player object is going to go out of the predetermined range, the player object into the defensive state. That is, the player object is also restricted to go out of the predetermined range.

According to the fourth embodiment, since the player object is restricted to go out of the predetermined range, it is possible to prevent the player object from being too far from other object.

A fifth embodiment is according to the first embodiment, wherein the defensive object moving portion moves the player object in the defensive state within at least the second range irrespective of the operating input received by the operation receiving portion.

According to the fifth embodiment, since the player object in the defensive state is moved into the second range without the operating input by the player, it is possible to surely return the player object to the second range from the position that the player object is invisible as existing outside the second range.

A sixth embodiment is according to the first embodiment, wherein the returning portion returns the player object changed into the defensive state to the state being not defended after the player object is moved from outside the second range to within the second range by the defensive object moving portion.

According to the sixth embodiment, since the player object changed to the defensive state is returned to the state being not defended after moved within the second range, it is possible to return the player object to the second range while ensuring safety.

A seventh embodiment is according to the first embodiment, wherein the returning portion returns the player object in the defensive state to the state being not defended based on an action of the player object not in the defensive state.

According to the seventh embodiment, since the player object in the defensive state is returned to the state being not defended based on the action of the player object not in the defensive state, it is possible to play the game in cooperation with another player.

A eighth embodiment is according to the seventh embodiment, wherein the returning portion returns, if and when the player object not in the defensive state is brought into contact to the player object in the defensive state, the player object in the defensive state to the state not being defended.

According to the eighth embodiment, it is possible to return the player object in the defensive state to its former state in the vicinity of the player object not in the defensive state.

A ninth embodiment is according to the seventh embodiment, wherein the returning portion returns, if and when a moving object which is moved based on an action of the player object not in the defensive state is brought into contact with the player object in the defensive state, the player object in the defensive state to the state not being defended.

According to the ninth embodiment, it is possible to return the player object in the defensive state to its former state even if the player object in the defensive state and the player object not in the defensive state are far from each other.

A tenth embodiment is according to the first embodiment, wherein the game program further causes the computer as an object displaying portion. The object displaying portion displays the player object in the defensive state from the player object not in the defensive state in an identifiable manner.

According to the tenth embodiment, it is possible to understand the player object in the defensive state or the player object not in the defensive state.

An eleventh embodiment is according to the tenth embodiment, wherein the object displaying portion displays the player object in the defensive state inside a predetermined object.

According to the eleventh embodiment, since the player object in the defensive state is displayed as existing inside a predetermined object, it is possible to represent a situation that the player object in the defensive state is not affected with an attack from outside.

A twelfth embodiment is according to the fifth embodiment, wherein the defensive object moving portion moves (returns) the player object in the defensive state within the second range from a position that the player object went out of the second range.

According to the twelfth embodiment, since the player object is returned within the second range from the position that the player object moves outside the second range, it is possible to know that the player object is changed to the defensive state because the player object goes out of the second range or that the player object is forcedly returned within the second range.

A thirteenth embodiment is according to the fifth embodiment, wherein the defensive object moving portion moves the player object in the defensive state to a center of the second range.

According to the thirteenth embodiment, since the player object in the defensive state is moved to a center of the second range, it is possible to move the player object in the defensive state to a position easy to see.

A fourteenth embodiment is according to the fifth embodiment, wherein the defensive object moving portion moves the player object in the defensive state so as to approach a specific player object not in the defensive state out of the plurality of player objects.

According to the fourteenth embodiment, since the player object in the defensive state is made to approach the player object not in the defensive state, it is possible to render the player object in the defensive state to be easily returned to the state not being defended. Furthermore, it is possible to make the player object in the defensive state to catch up another object.

A fifteenth embodiment is according to the fourteenth embodiment, wherein the game program further causes the computer as a range moving portion. The range moving portion moves the second range in accordance with the position of the specific player object. That is, the screen is scrolled in accordance with the position of the specific player object.

According to the fifteenth embodiment, since the player object in the defensive state is made to approach the specific player object which has the initiative or authorization for moving the second range, when the player object in the defensive state is returned to the state not being defended, this player object can be displayed at the position relatively easy to see.

A sixteenth embodiment is according to the first embodiment, wherein the first range has a shape obtained by analogously enlarging the second range.

According to the sixteenth embodiment, since the first range is formed in a shape that is expanded from the second range, it is possible to operate the player object which went out of the second range through prediction irrespective of the position that the player object went out.

A seventeenth embodiment is a game apparatus which each of a plurality of player objects moves within a first range in a virtual space according to an operation by each of a plurality of players, and a game screen based on a second range that is at least a part of the first range is displayed, comprising: an operation receiving portion which receives operating inputs from the plurality of players; an object controlling portion which moves respective player objects each assigned to each of the plurality of players within the first range in accordance with the operating inputs received by the operation receiving portion; a changing portion which changes, when a player object moved in accordance with an operating input by a player out of the plurality of players moves out of the second range, the player object into a defensive state defending the player object against an attack from an enemy object; a defensive object moving portion which moves the player object changed to the defensive state within at least the second range; and a returning portion which returns the player object changed to the defensive state to a state being not defended.

An eighteenth embodiment is a game controlling method for a computer in which each of a plurality of player objects moves within a first range in a virtual space according to an operation by each of a plurality of players, and a game screen based on a second range that is at least a part of the first range is displayed, wherein the computer performing: (a) receiving operating inputs from the plurality of players; (b) moving respective player objects each assigned to each of the plurality of players within the first range in accordance with the operating inputs received in the step (a); (c) changing, when a player object moved in accordance with an operating input by a player out of the plurality of players moves out of the second range, the player object into a defensive state defending the player object against an attack from an enemy object; (d) moving the player object changed to the defensive state within at least the second range; and (e) returning the player object changed to the defensive state to a state being not defended.

A nineteenth embodiment is a game system in which each of a plurality of player objects moves within a first range in a virtual space according to an operation by each of a plurality of players, and a game screen based on a second range that is at least a part of the first range is displayed, comprising: an operation receiving portion which receives operating inputs from the plurality of players; an object controlling portion which moves respective player objects each assigned to each of the plurality of players within the first range in accordance with the operating inputs received by the operation receiving portion; a changing portion which changes, when a player object moved in accordance with an operating input by a player out of the plurality of players moves out of the second range, the player object into a defensive state defending the player object against an attack from an enemy object; a defensive object moving portion which moves the player object changed to the defensive state within at least the second range; and a returning portion which returns the player object changed to the defensive state to a state being not defended.

According to the seventeenth to nineteenth embodiments, similar to the first embodiment, it is possible to enjoy the same together game even if the players have different abilities.

The above described objects and other objects, features, aspects and advantages of the embodiments will become more apparent from the following detailed description of the embodiments when taken in conjunction with the accompanying drawings.

### BRIEF DESCRIPTION OF THE DRAWINGS

FIG. 1 is an appearance view of a non-limiting example of a game apparatus.

FIG. 2 is a block diagram showing a non-limiting example of electrical structure of the game apparatus.

FIG. 3 is a block diagram showing a major portion of the electrical structure in FIG. 2.

FIG. 4 is a view showing a non-limiting example of a communication game system using the game apparatus of FIG. 1.

FIG. 5 is a view showing a non-limiting first example of a game screen displayed on a stereoscopic LCD in FIG. 1 and non-limiting examples of a virtual space, and a view for explaining a course of a virtual game and a displaying range.

FIG. 6 is a view showing non-limiting second and third examples of a game screen displayed on the stereoscopic LCD of FIG. 1.

FIG. 7 is a view for explaining non-limiting examples of scroll control lines and a movable range respectively set with respect to the displaying range.

FIG. 8 is a view showing non-limiting fourth and fifth examples of a game screen displayed on the stereoscopic LCD of FIG. 1.

FIG. 9 is a view showing non-limiting sixth and seventh examples of a game screen displayed on the stereoscopic LCD of FIG. 1.

FIG. 10 is a view showing non-limiting eighth and ninth examples of a game screen displayed on the stereoscopic LCD of FIG. 1.

FIG. 11 is a view showing a non-limiting example of a memory map of a main memory shown in FIG. 2.

FIG. 12 is a view for explaining a specific content of player object data shown in FIG. 11.

FIG. 13 is a flowchart showing a non-limiting example of a whole game process by a CPU shown in FIG. 2 and FIG. 3.

FIG. 14 is a flowchart showing a non-limiting example of a part of player object control processing by the CPU shown in FIG. 2 and FIG. 3.

FIG. 15 is a flowchart showing a non-limiting example of another part of the player object control processing by the CPU shown in FIG. 2 and FIG. 3, following FIG. 14.

FIG. 16 is a flowchart showing a non-limiting example of the other part of the player object control processing by the CPU shown in FIG. 2 and FIG. 3, following FIG. 14.

FIG. 17 is a flowchart showing a non-limiting example of scroll authorization changing processing by a CPU shown in FIG. 2 and FIG. 3.

FIG. 18 is a flowchart showing a non-limiting example of a part of scroll control processing by a CPU shown in FIG. 2 and FIG. 3.

FIG. 19 is a flowchart showing a non-limiting example of another part of the scroll control processing by the CPU shown in FIG. 2 and FIG. 3, following FIG. 18.

FIG. 20 is a flowchart showing a non-limiting example of the other part of the scroll control processing by the CPU shown in FIG. 2 and FIG. 3, following FIG. 19.

### DETAILED DESCRIPTION OF NON-LIMITING EXAMPLE EMBODIMENTS

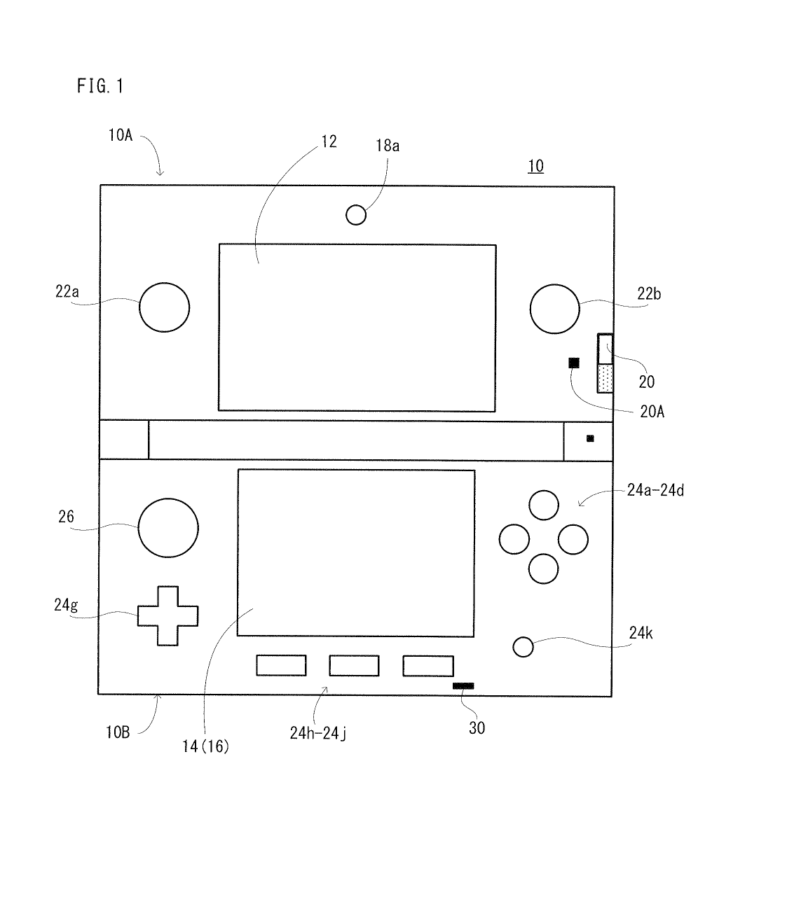

FIG. 1 shows an appearance of an example non-limiting game apparatus 10. The game apparatus 10 is a game apparatus of a foldable-type, and FIG. 1 shows a front surface of the game apparatus 10 in an opened state. As shown in FIG. 1, the game apparatus 10 is provided with an upper housing 10A and a lower housing 10B which are turnably or foldably connected to each other, and on a front surface of the upper housing 10A, there are provided with a stereoscopic LCD 12 compliant with an auto-stereoscopic display, an inward camera 18a, a 3D adjusting switch 20, a 3D lump 20A, left and right speakers 22a and 22b and so on. On a front surface of the lower housing 10B, there are provided with a lower LCD 14 with a touch panel 16, A, B, X and Y buttons 24a-24d, a cross key (button) 24g, Home, Select, Start buttons 24h-24j, a power button 24k, an analog pad 26 and a microphone 30. Although not shown, an L button 24e is provided over a left-side surface and a rear surface of the game apparatus 10, and an R button 24f is provided over a right-side surface and the rear surface.

The stereoscopic LCD 12 is a 3D (three-dimensional) LCD according to a parallax barrier system, and displays an image capable of being seen as a stereoscopic image with naked eyes (auto-stereoscopic image). In the stereoscopic LCD 12, it is possible to display a planar image) by turning-off parallax barrier by a barrier LCD. In addition, not limited to the parallax barrier system, a lenticular system utilizing a sheet with concaves/convexes (lenticular lens), and other glassless 3D systems may be adopted.

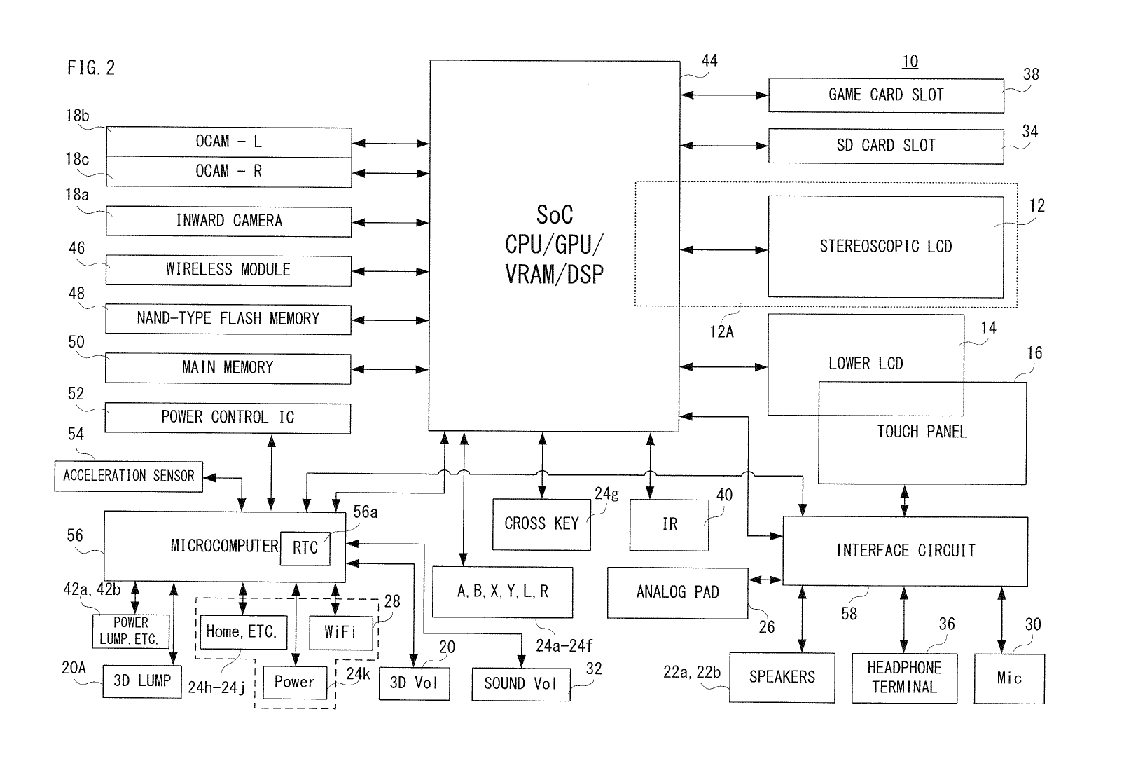

The inward camera 18a takes a planar image (2D image), and outward cameras 18b and 18c (shown in FIG. 2) take a stereopsis image (3D image). A 2D or 3D image taking a player or user (hereinafter, simply called as “player”) can be utilized as an image input to an application program such as information processing program. The 2D image by the inward camera 18a can be also displayed on the lower LCD 14 and the 3D image by the outward cameras 18b and 18c can be displayed on the stereoscopic LCD 12.

The 3D adjusting switch 20 is a slide switch which is for performing manual switching between the 3D and the 2D as to the displaying on the stereoscopic LCD 12, and for performing manual adjustment of three-dimensional effect in the 3D.

In addition, although a detailed description is omitted here, such a change in the three-dimensional effect is implemented through changing a distance between a left and right virtual cameras (not shown) arranged within a virtual space, i.e., a distance D between cameras. That is, in response to an operation of the 3D adjusting switch 20, the distance-between-cameras D is adjusted. The distance-between-cameras D is, thus, not only manually adjusted, but subjected to automatic adjustment by the information processing program.

The 3D lump 20A is a lump indicating a displaying state of the stereoscopic LCD 12, which is turned-on at the 3D and turned-off at the 2D. In addition, not only simply turned-on or -off, but also brightness and/or color may be changed according to a degree of the 3D (large or small of the 3D effect).

Operations to the touch panel 16, A, B, X, Y buttons 24a-24d, cross key (button) 24g, Home, Select, Start buttons 24h-24j or the analog pad 26 is utilized as a touch/button/pad inputs in the information processing program. The power button 24k is used for turning-on/off the power of the game apparatus 10. The power lump 42a is turned-on/off in conjunction with the turning-on/off of the power.

The microphone 30 converts the user's speech voice, an environmental sound and so on into sound data. The sound data is utilizable as a sound input in the information processing program. In this case, the information processing program detects the user's speech voice by performing sound recognition, and executes processing according to a detection results. The sound data by the microphone 30 is also recordable on a NAND-type flash memory 48 (see FIG. 2).

The speakers 22a and 22b output a sound of music (BGM), a game sound, a microphone sound and so on. A headphone, not shown, is connected to a headphone terminal 36. A sound volume adjusting switch 32 is a slide switch for adjusting a sound volume by the speakers 22a and 22b or an output of the headphone terminal 36.

In FIG. 2, the electrical structure of the game apparatus 10 is shown. The game apparatus 10 includes an SoC (System-on-a-Chip) 44 being constructed by a CPU, a GPU, a VRAM, a DSP, etc. The SoC 44 is connected with the above-described stereoscopic LCD 12, the lower LCD 14, the inward camera (In camera) 18a, left and right outward cameras (OCAM-L and OCAM-R) 18b and 18c, A, B, X, Y, L, R buttons 24a-24f, the cross button 24g, an SD card slot 34, a game card slot 38 and an infrared ray emitting-receiving unit (IR) 40. The SoC 44 is further connected, via a microcomputer 56, with the above-described 3D adjusting switch (3D Vol) 20, the 3D lump 20A, Home, Select, Start buttons 24h-24j, the power button (Power) 24k, a wireless switch (WiFi) 28, the sound volume adjusting switch (sound volume Vol) 32, and a power, wireless lumps 42a and 42b. The SoC 44 is moreover connected, via an IF circuit 58, with the above-described touch panel 16, the left and right speakers 22a and 22b, the analog pad 26, the microphone (Mic) 30 and the headphone terminal 36.

In addition, the SoC 44 is connected with a wireless module 46, the NAND-type flash memory 48 and a main memory 50 as elements other than those described above. The wireless module 46 has a function connecting to a wireless LAN. Therefore, although not shown, the game apparatus 10 is capable of communicating with other game apparatus 10 and the computer directly or via a network. The NAND-type flash memory 48 stores saving data such as camera images, microphone sounds and so on. The main memory 50 provides a working area to the SoC 44. More specifically, the main memory 50 is stored with various data and programs used in an application (information processing) such as a game, and the SoC 44 performs works with utilizing the data and the programs stored in the main memory 50.

The microcomputer 56 is connected with a power control IC 52 and an acceleration sensor 54. The power control IC 52 performs a power control of the game apparatus 10 and the acceleration sensor 54 detects accelerations of the game apparatus 10 in three-axis directions. A detection result of the acceleration sensor 54 is utilizable as a motion input to the information processing program. In this case, the information processing program calculates a motion of the game apparatus 10 itself based on the detection result, and executes a process according to a calculation result. Furthermore, the microcomputer 56 includes an RTC (real time clock) 56a, and the RTC 56a counts a time to supply to the SoC 44.

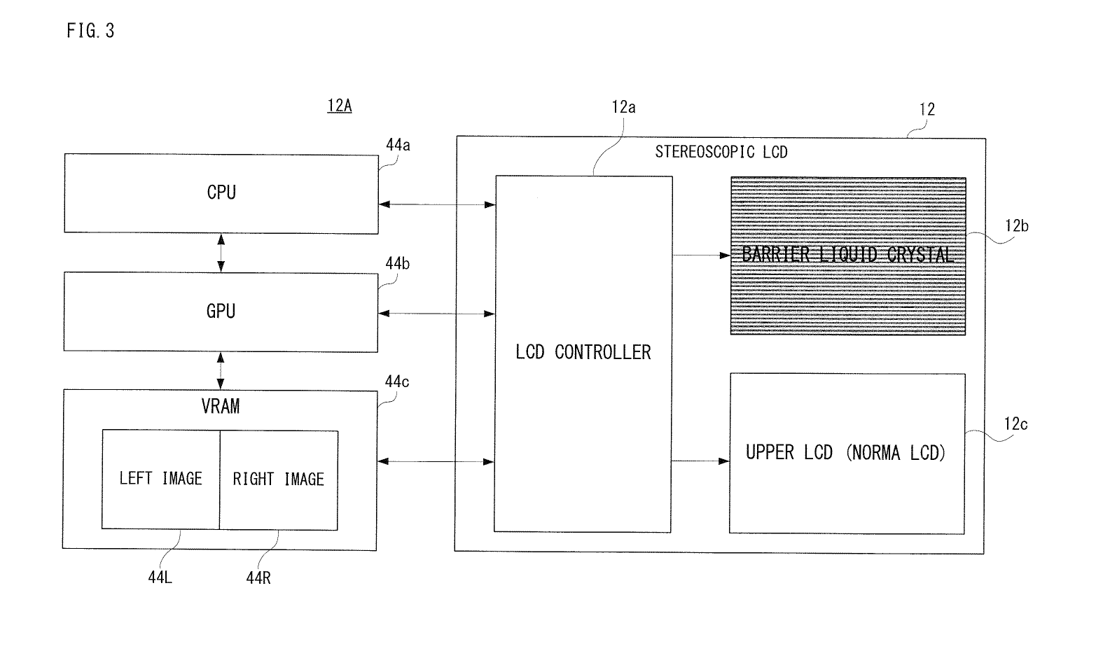

In FIG. 3, a stereoscopic LCD control portion 12A constructed by the stereoscopic LCD 12 and a part of the SoC 44 is shown. The stereoscopic LCD 12 includes an LCD controller 12a, a barrier LCD 12b and the upper LCD 12c. The barrier LCD 12b includes a plurality of LCD slits each extending in the vertical (column) direction, and by alternately shuttering a light from a backlight by the plurality of LCD slits, the right eye and left eye can see a light passing the pixels in different columns of the upper LCD 12c. The upper LCD 12c may be a normal LCD (for 2D displaying) as similar to the lower LCD 14. The LCD controller 12a performs image rendering on the upper LCD 12c under a control of the GPU 44b and thus the CPU 44a, and turns-on/off a voltage applied to the barrier LCD 12b. If the barrier LCD 12b is turned-off, the right eye and left eye become to see a light passing the pixel in any all columns of the upper LCD 12c.

In addition, FIG. 3 shows that the LCD controller 12a, the GPU 44b and the VRAM 44c are provided in relation to the stereoscopic LCD 12, and a LCD controller, a GPU and a VRAM are also provided in relation to the lower LCD 14. As can be understood by reference to FIG. 3, the GPU corresponding to the lower LCD 14 is also connected to the CPU 44a in a manner that a signal can be transmitted and received therebetween, and the GPU and the VRAM both corresponding to the lower LCD 14 are connected to each other in a manner that a signal can be transmitted and received therebetween. Then, the CPU 44a, the GPU and the VRAM each corresponding to the lower LCD 14 are respectively connected to the LCD controller corresponding to the lower LCD 14 in a manner that a signal can be transmitted and received between the LCD controller and each of the CPU 44a, the GPU and the VRAM, and to the LCD controller, the lower LCD 14 is connected.

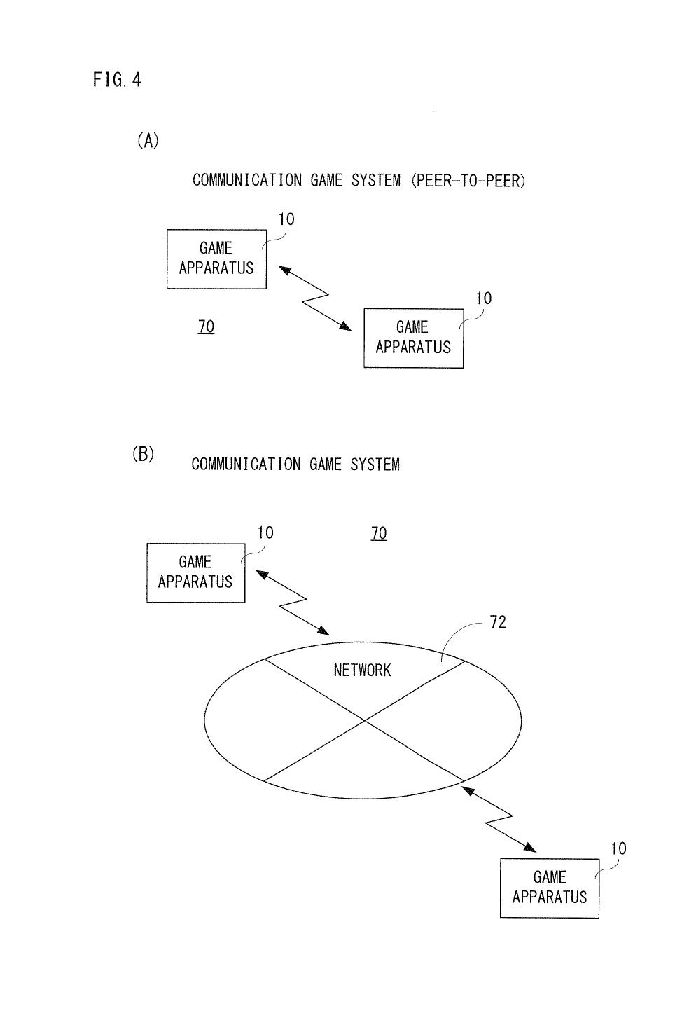

Such a game apparatus 10 performs a communication game by performing a communication with a further game apparatus 10. As shown in FIG. 4(A), the game apparatus 10 constitutes a communication game system 70 by performing a communication (wireless communication) directly with the further game apparatus 10. The game apparatus 10 may be connected to the further game apparatus 10 with a wire or cable. In another communication game system 70, as shown in FIG. 4(B), the game apparatus 10 communicates with the further game apparatus 10 via a network 72 such as an internet, LAN or the like.

In addition, in this embodiment shown, a case that a communication game is played with two game apparatuses 10 will be described; however, the communication game can be played with three or more game apparatuses.

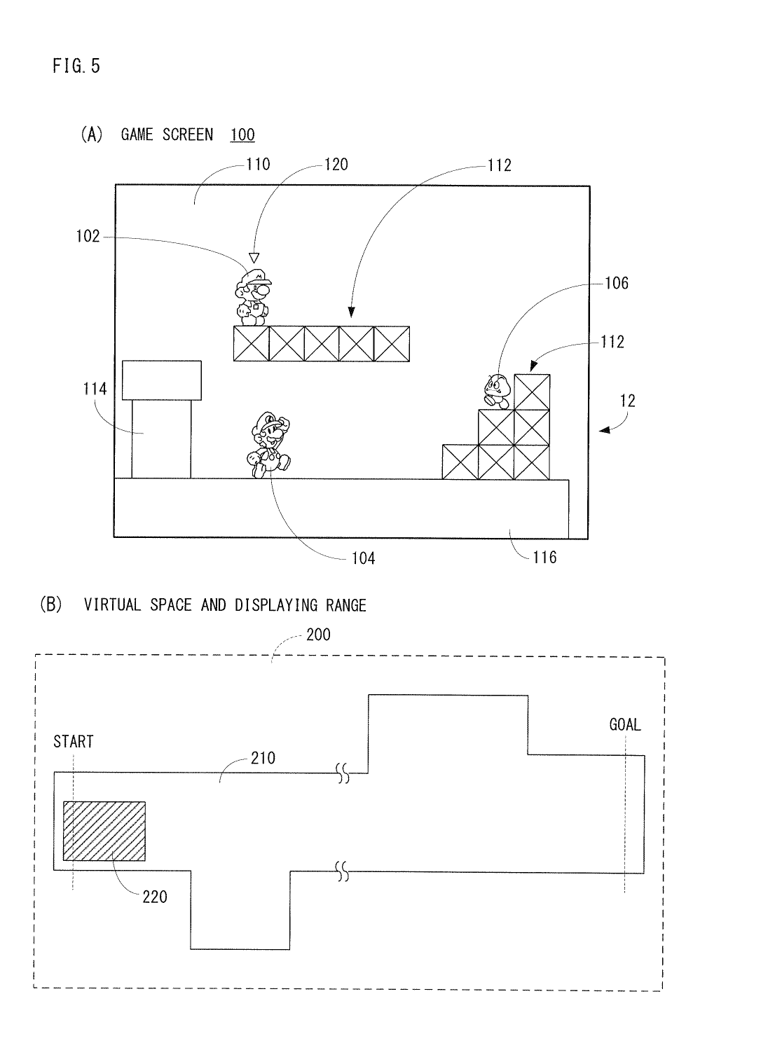

FIG. 5 shows an example of a game screen 100 displayed on the stereoscopic LCD 12 of each of the game apparatuses 10 when the communication game is played in the communication game system 70 shown in FIG. 4(A) or FIG. 4(B). That is, in the communication game (virtual game) of this embodiment, the same game screen 100 is displayed in each of the game apparatuses 10 operated by the players of the communication game.

As shown in FIG. 5(A), a first player object 102, a second player object 104 and an enemy object 106 are displayed in the game screen 100. In addition, in the game screen 100, a background image 110 is also displayed. As the background image 110, wall surfaces and scenery (not shown) are displayed in the rearmost surface, and a background object such as a block object 112, a pipe object 114 and a ground (or a floor) object 116 is displayed in front thereof. Furthermore, a designating image 120 is displayed above the first player object 102.

The first player object 102 is operated by one operator (player) of the two game apparatuses 10, and the second player object 104 is operated by the other player. The first player object 102 and the second player object 104 respectively move in a course or game field provided in a virtual space or perform an arbitrary operation (action) in accordance with operations by the players. In this embodiment, such a movement or action includes, walking, running, jumping, swimming, flying, going up and down (with elevator, vine, rope, ladder, steps), falling, attacking (with punch, kick, stump, hip drop, use of a shooting weapon), stepping on a button (switch) object, opening or closing a door object, coming and going to or from the pipe object 114 or a canon object, acquiring an item, etc.

In addition, the hip drop means an action that the player object (102, 104) falls down on the hips in the vertically downward direction from a state that the same is in an air by jumping or the like. For example, if the hips hit the enemy object 106, it is possible to beat the enemy object 106, and, if the hips hit the block object 112, it is possible to strike or destroy the block object 112.

Furthermore, each of the first player object 102 and the second player object 104 changes its state (transmogrification) by acquiring a predetermined item. In this embodiment shown, in a default state (initial state) not being transmogrified, the player object (102, 104) is at a size of a second smaller out of the sizes categorized into four stages, and therefore, the player object can hit the block object 112 but cannot destroy the block object 112. Furthermore, the player object (102, 104) can be transmogrified into various states by acquiring a predetermined object and in accordance with a kind of the acquired predetermined object. Specifically, the player object can be transmogrified into a state (a smallest state) that a size is the smallest but a jumping force is larger than that in the default state, a state (an enlarged state) that a size is larger than that in the default state by one step and capable of destroying the block object 112 by striking the same, a state (a gigantic state) that a size is larger than that of the default state by two steps (largest size) and capable of destroying (routing) the block object 112 or the pipe object 114 only by touching, a state capable of using a predetermined shooting weapon, a state capable of flying, or an invincible state. Hereinafter, in this embodiment, including the default state not being transmogrified, these states may be called as “transmogrification state”.

In addition, the invincible state is a state that the enemy object 106 can be knocked down only by the player object (102, 104) touching the enemy object 106, but the block object 112 and the pipe object 114 cannot be destroyed only by touching them, and therefore the invincible state is different from a defensive state described later. In the invincible state, the player object (102, 104) moves or performs an arbitrary action in accordance with an operation by the player. In contrast, in the defensive state, essentially, the player object (102, 104) cannot be operated. Briefly described, irrespective of the operation by the player, the player object (102, 104) is made move in a predetermined direction and does not perform any arbitrary action while a moving speed is changed according to the operation by the player. Details of the defensive states will be described later. It is to be noted that the kinds and the number of the above-described transmogrification state are mere examples, and thus, not to be limited thereto. It is possible to arbitrarily change the contents and the number of the transmogrification states.

Furthermore, each of the gigantic state and the invisible state is continued during a predetermined time period, and then, the player object (102, 104) returns to a previous state from which such the gigantic state or the invisible state is changed. Furthermore, if the player object (102, 104) makes a failure in the smallest state or the default state, the player object (102, 104) is returned into the virtual game with the defensive state when the other player object (102, 104) does not makes a failure. A transmogrification state at this time is the default state. If the player object makes a failure in the enlarged state, the transmogrification state is returned to the default state, and if the player object (102, 104) makes a failure in the state capable of using a predetermined shooting weapon or the state capable of flying, the transmogrification state is returned to the enlarged state (or the default state).

The background object such as the block object 112, the pipe object 114 and the ground (or floor) object 116 is arranged at predetermined positions within the virtual space, and the course or game field is produced within the same virtual space. Respective arranging positions are determined in advance by a developer or a programmer (designer) of that virtual game.

In the virtual game according to this embodiment, if the first player object 102 and the second player object 104 move from a start position to a goal position of the course, the course is cleared. During a play of the virtual game, according to the operation by the player, the player object (102, 104) knocks down various kinds of a plurality of enemy objects (106) existing in the course or avoids the same and advances in the course while moving or destroying a predetermined object (112).

For example, the predetermined object (item) includes a coin object or a mushroom object for increasing remaining lives of the player object (102, 104), a further mushroom object for changing a transmogrification state of the player object (102, 104), a flower object, a leaf object and a star object. For example, the predetermined object (item) appears in the course by the player object (102, 104) hitting a predetermined block object 112, or is arranged at a predetermined position in the course.

As shown in FIG. 5(B), a predetermined course 210 is generated within the virtual space 200. An image for a partial range (displaying range) 220 of the course 210 is displayed on the stereoscopic LCD 12 as the game screen 100. In addition, for simplification, in FIG. 5(B), various objects (102, 104, 106, 112, 114, 116) in the course 210, the background image 110, etc. are omitted, and slant lines are applied to the displaying range 220.

In this embodiment, a three-dimensional objects are drawn in a three-dimensional virtual space 200, and by imaging the object by a virtual camera (not shown), the game screen 100 seen as a two-dimension is displayed; however, a two-dimensional object may be drawn in a two-dimensional virtual space, and the object may be imaged by a virtual camera.

During a play of the virtual game, the displaying range 220 is moved in accordance with a movement of the player object (102, 104) designated by the designating image 120. That is, the game screen 100 is scrolled. In the virtual game of this embodiment, the game screen 100 is essentially scrolled in a horizontal direction, but there is an occasion that the game screen 100 is scrolled in a vertical direction in a part of the course 200, and further, there is a course 210 that is scrolled in the vertical direction.

Furthermore, in the virtual game of this embodiment, the player object (102, 104) designated by the designating image 120 or the player operating the concerned player object has authorization or initiative for moving the displaying range 220, that is, for scrolling the screen displayed on the stereoscopic LCD 12 (game screen 100). Hereinafter, such the authorization or initiative is called as “scroll authorization”. As described later, the scroll authorization is moved between the player objects (102, 104).

This is a reason that if the displaying range 220 is intended to be moved in accordance with the movements of both of the first player object 102 and the second player object 104, it is impossible to suitably move the displaying range 220 in a case that the first player object 102 and the second player object 104 are advancing in different directions. A further reason is that if the displaying range 220 is intended to be moved according to the movement of only one player object (102, 104), it is necessary for the player of the other player object (104 or 102) to operate the other player object (104 or 102) to follow the movement of the player object (102, 104), and thus, that is not fair and a feeling of operation is impaired.

In addition, the displaying range 220 is an imaging range determined by an angle of view of the virtual camera, and thus, if the position of the virtual camera is changed, the displaying range 220 is moved.

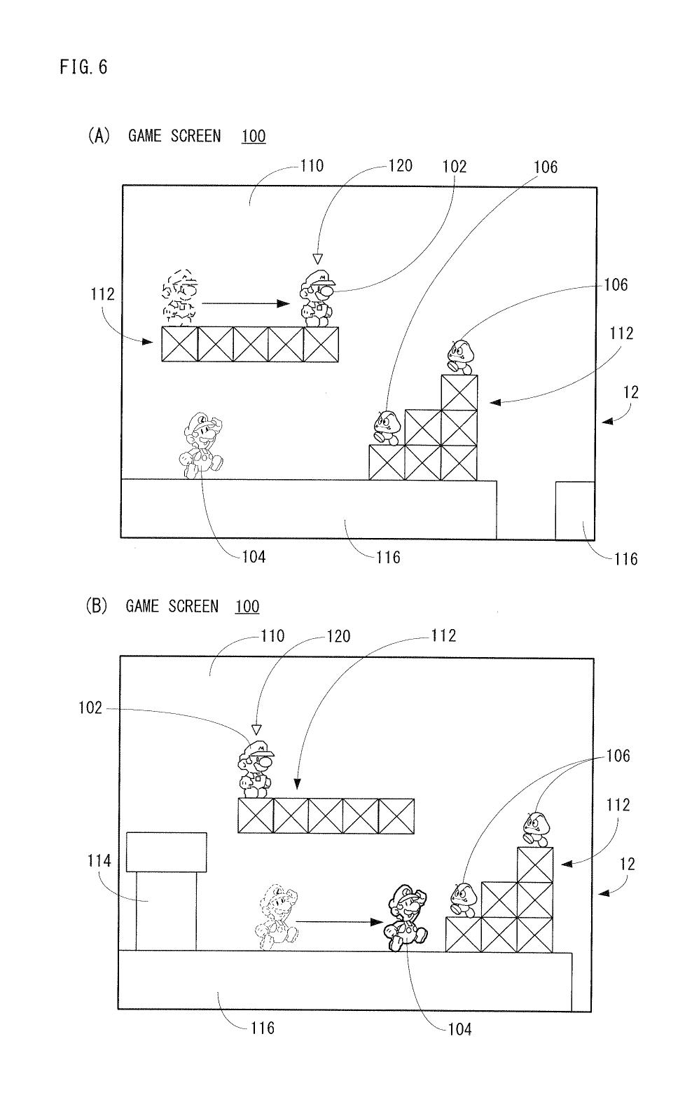

In a state shown in FIG. 5(A), for example, if and when the first player object 102 having the scroll authorization is moved rightward, the displaying range 220 is moved to rightward, and therefore, as shown in FIG. 6(A), the game screen 100 is scrolled in the rightward direction. On the other hand, in a state shown in FIG. 5(A), in a case that the second player object 104 not having the scroll authorization is moved rightward, as shown in FIG. 6(B), the game screen 100 is not scrolled because the first player object 102 designated by the designating image 120, that is, having the scroll authorization is in a resting state.

Although not shown, this is similarly applied to a case that the game screen 100 is scrolled in other directions (leftward direction, upward direction or downward direction). In addition, the scroll of the game screen 100 (movement of the displaying range 220) is controlled based on a moving direction and a current position (position coordinates) of the player object (102, 104) having the scroll authorization.

In a case that the player object (102, 104) having the scroll authorization is stopped, a direction that the face of the player object (102, 104) is turned is the moving direction.

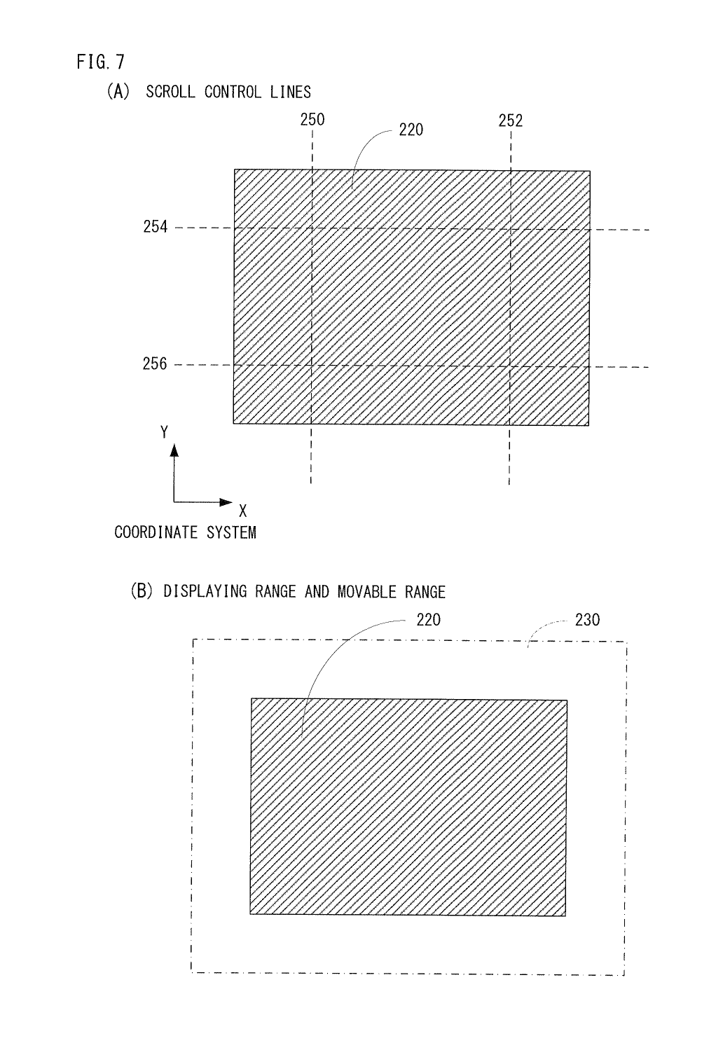

In this embodiment shown, four lines (hereinafter, called as “scroll control line”) each of which becomes the criteria for determining whether or not the screen is to be scrolled is set in correspondence to the displaying range 220. Specifically, as shown in FIG. 7, with respect to the displaying range 220, the scroll control lines 250, 252, 254 and 256 are set; however, these scroll control lines 250-256 are not displayed on the stereoscopic LCD 12 (game screen 100).

Since the displaying range 220 is determined by the position and the imaging range of the virtual camera as described above, in fact, the four scroll control lines are set in accordance with the position of the virtual camera.

In this embodiment shown, the scroll of the game screen 100 is controlled such that the player object (102, 104) having the scroll authorization does not go out of a range formed by the scroll control lines 250-256. In a case that the moving direction of the player object (102, 104) having the scroll authorization is the rightward direction, the displaying range 220 is moved toward right such that the scroll control line 250 is brought into contact with (overlapped with) a left end of the player object (102, 104), and accordingly, the game screen 100 is scrolled toward right with the same or approximately the same speed as the moving speed of the player object (102, 104) having the scroll authorization. That is, in a case that the moving direction of the player object (102, 104) having the scroll authorization is the rightward direction, the player object (102, 104) is never located at a left side across the scroll control line 250.

As described above, in a case that the game screen 100 is scrolled toward right, if the player object (102, 104) having the scroll authorization changes its moving direction from the right to the left, until the scroll control line 252 is brought into contact with (overlapped with) a right side of the player object (102, 104), the game screen 100 is scrolled toward left at a speed faster than the moving speed of the player object (102, 104). That is, if the moving direction of the player object (102, 104) having the scroll authorization is the leftward direction, the player object (102, 104) is never located at a right side across the scroll control line 252.

A coordinate system is set for the virtual space 200, and as shown in FIG. 7(A), an axis in parallel with the horizontal direction is an X axis, and an axis in parallel with the vertical direction is a Y axis. The rightward direction, i.e., the advancing direction (see FIG. 5(B)) in FIG. 7(A) is an increasing direction of the X axis, and an upper direction in FIG. 7(A) is an increasing direction of the Y axis. For simplification, a depth direction (Z axis) is omitted here.

If the player object (102, 104) having the scroll authorization is moved toward right, the displaying range 220 is moved toward right according to the movement of the player object (102, 104) such that the X coordinate defining a position of the scroll control line 250 is coincident with the X coordinate of the left end point of the player object (102, 104).

A reason why the scroll control line 250 is set at a left side from the center of the displaying range 220 is for presenting to the player the situation at a side of the advancing direction of the course 220 more largely in a case that the player object (102, 104) is moved in the rightward direction. Other scroll control lines 252, 254 and 256 are set at positions based on the same reason.

Furthermore, in a case that the player object (102, 104) having the scroll authorization is moved toward left, the displaying range 220 is moved toward left according to the movement of the player object (102, 104) such that the X coordinate defining the position of the scroll control line 252 is coincident with the X coordinate of the right end point of the player object (102, 104). Therefore, the game screen 100 is scrolled toward left according to the movement of the player object (102, 104) having the scroll authorization.

In a case that the player object (102, 104) having the scroll authorization is moved upward, the displaying range 220 is moved upward according to the movement of the player object (102, 104) such that the Y coordinate defining the position of the scroll control line 256 is coincident with the Y coordinate of the lower end point of the player object (102, 104). Therefore, the game screen 100 is scrolled upward according to the movement of the player object (102, 104) having the scroll authorization.

In a case that the player object (102, 104) having the scroll authorization is moved downward, the displaying range 220 is moved downward according to the movement of the player object (102, 104) such that the Y coordinate defining the position of the scroll control line 254 is coincident with the Y coordinate of the upper end point of the player object (102, 104). Therefore, the game screen 100 is scrolled downward according to the movement of the player object (102, 104) having the scroll authorization.

Since as described above, in the virtual game of this embodiment shown, the game screen 100 is scrolled essentially in the horizontal direction, in a case that it is not necessary to scroll the screen in the upward direction or the downward direction, the scroll control processing itself is not executed, or the game screen 100 is not scrolled even if the game screen 100 is determined to be scrolled in the upward direction or the downward direction.

Such a method for scrolling the game screen 100 is only one example, another method may be adopted as far as the game screen is scrolled in accordance with the movement of the player object (102, 104) having the scroll authorization. For example, a point (coordinates) by which a positional relationship between the scroll control lines 250-256 and the player object (102, 104) having the scroll authorization is determined may be changed. More specifically, in a case that the player object (102, 104) having the scroll authorization is moved in the rightward direction, the game screen 100 may be controlled such that the scroll control line 250 is made coincident with the right end of the player object (102, 104). In a case that the player object (102, 104) having the scroll authorization is moved in the leftward direction, the game screen 100 may be controlled such that the scroll control line 252 is made coincident with the left end of the player object (102, 104). In a case that the player object (102, 104) having the scroll authorization is moved in the upward direction, the game screen 100 may be controlled such that the scroll control line 256 is made coincident with the upper end of the player object (102, 104). In a case that the player object (102, 104) having the scroll authorization is moved in the downward direction, the game screen 100 may be controlled such that the scroll control line 254 is made coincident with the lower end of the player object (102, 104).

Furthermore, the scroll control may be performed such that the coordinates of the center position of the player object (102, 104) having the scroll authorization and the coordinates defining the position of each of the scroll control lines 250-256 is coincident with each other.

Furthermore, in this embodiment shown, there is an occasion that the scroll authorization is transferred to another player object (102, 104) when a predetermined condition is satisfied. The predetermined condition may be satisfied based on an operation by the player, progress of the virtual game, or an action, a position or a state of the player object (102, 104). In the following, a description will be made specifically, but since the virtual game is progressed in accordance with an operation by the player and since the predetermined condition is satisfied if the player object (102, 104) performs an action, moves (changes in position), changes in transmogrification state, changes to the defensive state in response to the operation of the player, it is not necessary to surely distinct about factors (causes) satisfying the predetermined condition.

For example, if the player object (102, 104) not having the scroll authorization performs a predetermined action (hip drop, etc.) against the player object (102, 104) having the scroll authorization by the operation of the player, the scroll authorization is transferred or shifted.

In addition, the predetermined action may include throwing the player object (102, 104) having the scroll authorization by the player object (102, 104) not having the scroll authorization, collision of the player object (102, 104) not having the scroll authorization and the player object (102, 104) having the scroll authorization.

In a case that the game screen 100 (scene) is changed, the scroll authorization is transferred to the player object (102, 104) performing an action for changing the game screen 100; however, there is a case that without the scroll control using the scroll control lines 250-256, the game screen 100 is forcedly scrolled when the player object (102, 104) is brought into contact with a trick or device or when a trick or device is activated, whereby the scene is changed.

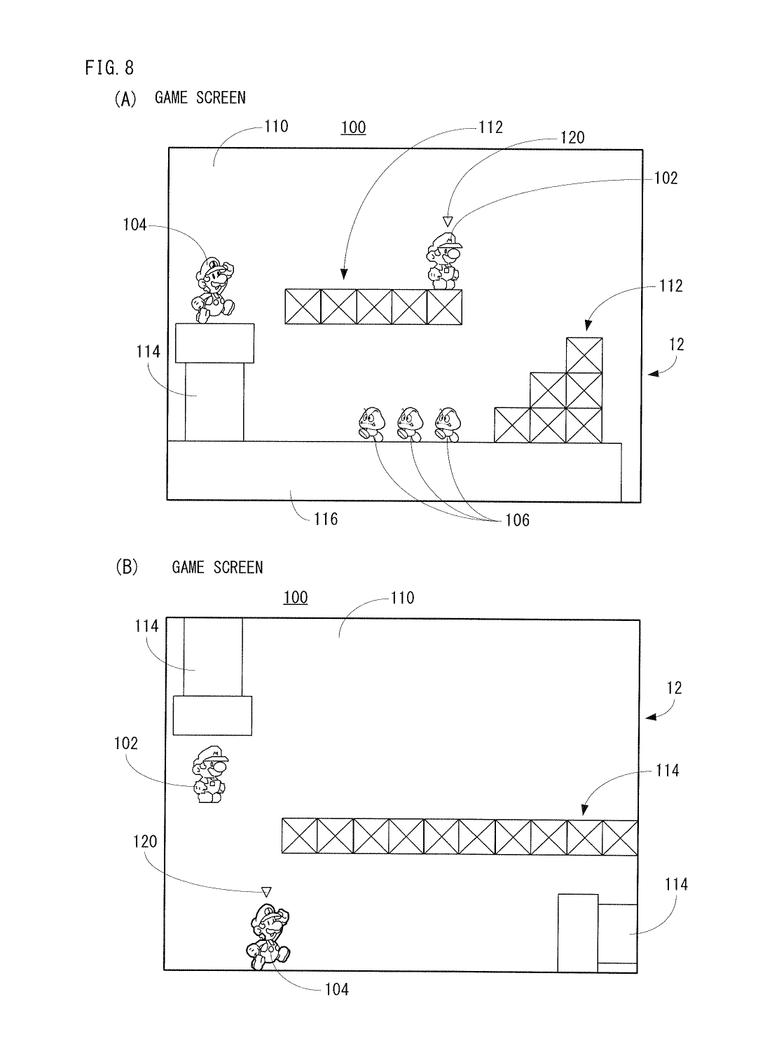

As shown in FIG. 8(A), in a case that the first player object 102 has the scroll authorization, for example, if the second player object 104 who does not have the scroll authorization enters the pipe object 114 first, as shown in FIG. 8(B), the scene is changed from a scene on the ground to a scene under the ground. At this time, the scroll authorization is transferred from the first player object 102 to the second player object 104. Likewise, if the player object passes a gate way, a scene is changed from an indoor scene to an outdoor scene or from an outdoor scene to an indoor scene, and in such a case, the scroll authorization is transferred to the player object (102, 104) who first passes the gate way. The scroll authorization is also handed over in the similar manner in a case that, if the player object (102, 104) jumps on a jump board, flies, climbs a vine, a scene on the ground is changed to a scene in the sky, or if the player object falls, a scene in the sky is changed to a scene on the ground. In such a case, a scroll authorization is transferred to the player object (102, 104) who first reaches a position that the scene on the ground is changed to the scene in the sky or a position that the scene in the sky is changed to the scene on the ground.

However, in any one of the above-described cases, if the player object (102, 104) to whom the scroll authorization to be transferred already has the scroll authorization, the scroll authorization is not transferred.

Furthermore, the scroll authorization is transferred from the player object (102, 104) who is changed in the defensive state by making a failure or according to an operation of the player, to the player object (102, 104) not being changed to the defensive state. Here, the defensive state means a state that the player object (102, 104) is included in (covered by) the soap-bubble object 130 and thus, the player object (102, 104) in the defensive state is not hit by the enemy object 106 or the attack by the enemy object 106, or the player object (102, 104) does not hit the background object such as the block object 112, the pipe object 114, the ground (or a floor) object 116 and so on, and therefore, passes them through to move toward the predetermined player object (102, 104). In this embodiment shown, the predetermined player object (102, 104) is a player object which is not in the defensive state. Furthermore, in this embodiment shown, in a case that there are the first player object 102 and the second player object 104 and one player object (102 or 104) is being in the defensive state, the scroll authorization is held by the predetermined player object (104 or 102) not being in the defensive state. Therefore, it is possible to say that the player object (102 or 104) who is in the defensive state is moved to approach the player object (104 or 102) having the scroll authorization.

In addition, for the player object (102, 104) not in the defensive state, the above-described transmogrification state may be changed; however, for the player object (102, 104) being in the defensive state, the above-described transmogrification state is not changed.

Furthermore, by covering the player object by the soap-bubble object 130, it is indicated that the player object (102, 104) being included in the object 130 is in the defensive state that the player object (102, 104) is not hit by the attack from the enemy object 106. Therefore, it is easy to understand that the player object (102, 104) is in the defensive state.

Furthermore, if the transmogrification state of the player object (102, 104) is brought to a predetermined state, the scroll authorization is transferred to the player object (102, 104) who becomes in the predetermined state. Here, the predetermined state is the gigantic state of the player object (102, 104). Since a plurality of player objects (102, 104) are not simultaneously transmogrified to the predetermined state, the scroll authorization is set to be transferred to the player object (102, 104) changed into the predetermined state.

In a case that the player object (102, 104) first reaches a goal or first passes a passing point (saving point), to this player object (102, 104), the scroll authorization is transferred. That is, in a case that the relationship between the position of the player object (102, 104) and a specific position satisfies a predetermined condition, the scroll authorization is transferred. Here, the scroll authorization is transferred to the player object (102, 104) first reaches or passes the specific position; however, the scroll authorization may be transferred at every time that the player object (102, 104) reaches or passes the specific position. Furthermore, if the player object (102, 104) knocks-down the enemy object 106 being a boss, operates a trick or device for knocking-down the boss enemy object 106 (depresses an object of a button or switch), the scroll authorization is also transferred to such the player object (102, 104). A reason why the embodiment is made like this is for showing a dramatic effect representing the reaching the goal, the passing of the passing point, or the knock-down the boss to the player through the game screen 100 in the progress of the virtual game.

Returning to FIG. 7(B), in this embodiment, a range (hereinafter called as “movable range”) 230 which corresponds to the displaying range 220 and in which the player object (102, 104) is movable is set. In this embodiment, the movable range 230 has a shape or form that the displaying range 220 is similarly enlarged and has a size that an outer peripheral of the displaying range 220 is extended uniformly. For example, a length or distance moving (expanding) the respective sides of the outer peripheral of the displaying range 220 outward is a length or a distance in a case that the block object 112 is arranged by eight (8) units (equal to a length of 8 units=128 dots); however, it is not necessary to limit a shape and a size of the movable range 230 to the above-described shape and size. In a case that the game screen 100 is scrolled only in the horizontal direction, it is unnecessary to provide movable areas above and below the displaying range 220.

Therefore, the player object (102, 104) not having the scroll authorization can be moved outside the game screen 100 (displaying range 220) or exists outside the game screen 100. That is, in the virtual space 200, the player object (102, 104) is moved in a first range such as the movable range 230, and an image of a second range narrower than the first range, i.e. the displaying range 220 is displayed on the stereoscopic LCD 12 as the game screen 100.

In addition, the movable range 230 and the displaying range 220 are only examples of the first range and the second range, and not limited thereto. For example, the first range may be an entire range of the course or the game field, and the second range may be a movable range of the player object. Furthermore, the first range and the second range may be the same range or may be in shapes different from each other. Furthermore, it is not necessary to render the second range and the displaying range 220 coincident with each other, and a portion of the second range may be rendered as the displaying range 220 and a range including the second range (narrower than the first range) may be made as the displaying range 220.

A reason why the movable range 230 is thus made larger than the displaying range 220 is not to impair the failing of operation. More specifically, if the displaying range 220 and the movable range 230 are made the same, there is an occasion that the player object (102, 104) operated by a less-skilled player delays the player object (102, 104) operated by a high-skilled player, in such a case, the player object (102, 104) operated by the less-skilled player becomes to be sandwiched by the end of the displaying range 220 and the background object (112, 114), and as a result, a failure occurs or such the object is moved just like being pushed by the end of the displaying range 220, and therefore, the failing of operation is impaired. Furthermore, the movable range 230 has a shape that the displaying range 220 is enlarged with similarity, even if the player object (102, 104) exists outside the displaying range 220 being thus non-displayed, the player can operate such the player object (102, 104) with a conjecture.

As described above, since the player object (102, 104) having the scroll authorization is controlled to move within a range defined by the scroll control lines 250-256, such the player object (102, 104) never go out of the displaying range 220. That is, the player object (102, 104) having the scroll authorization is necessarily included within the displaying range 220. Therefore, the player who operates the player object (102, 104) having the scroll authorization can operate with viewing the player object (102, 104) and a situation surrounding the same.

As described above, the player object (102, 104) not having the scroll authorization may move in the movable range 230 broader than the displaying range 220; however, if the player object (102, 104) not having the scroll authorization is too much separated from the player object (102, 104) having the scroll authorization, there is an occasion that the player object not having the scroll authorization is sandwiched between the end of the movable range 230 and the background object (112, 114) at an out-of-sight location like being outside the game screen 100, and a failure may occur.

Therefore, in this embodiment shown, in a case that the player object (102, 104) not having the scroll authorization exists outside the displaying range 220, if one of two conditions (different from the above-described predetermined condition) is satisfied, the player object (102, 104) is forcedly moved (returned) in the displaying range 220. That is, a time or a moving range that the player object (102, 104) exists outside the displaying range 220 is limited. In this embodiment, in a case that the player object (102, 104) is forcedly returned into the displaying range 220, the player object (102, 104) is changed into the defensive state. Since the player object (102, 104) existing outside the displaying range 220 is thus forcedly returned to the displaying range 220 in the defensive state, in a case that such the player object (102, 104) delays from a further player object (102, 104), for example, it is possible to make the player object (102, 104) being delayed catch up with the further player object (102, 104) to some extent, while ensuring the safety. Therefore, players having different skills can play the virtual game together.

A first condition is that a time that the player object (102, 104) exists outside the displaying range 220 reaches or exceeds a predetermined time period (180 frames, for example). In addition, the “frame” is a unit time for renewing a screen, and 1 (one) frame is equal to 1/60 seconds. A second condition is that the player object (102, 104) is going to go out of the movable range 230. In addition, there is an occasion that the player object (102, 104) is going to go out of the movable range 230 (1) in response to the operation by the player for the player object (102, 104), (2) in response to the movement of a further player object (102, 104), or (3) in response to both of them. Specifically describing the case of (2), if the game screen 100 is scrolled in accordance with the movement of the other player object (102, 104) having the scroll authorization, the displaying range 220 and the movable range 230 are moved, and therefore, the player object (102, 104) is going to go out of the movable range 230.

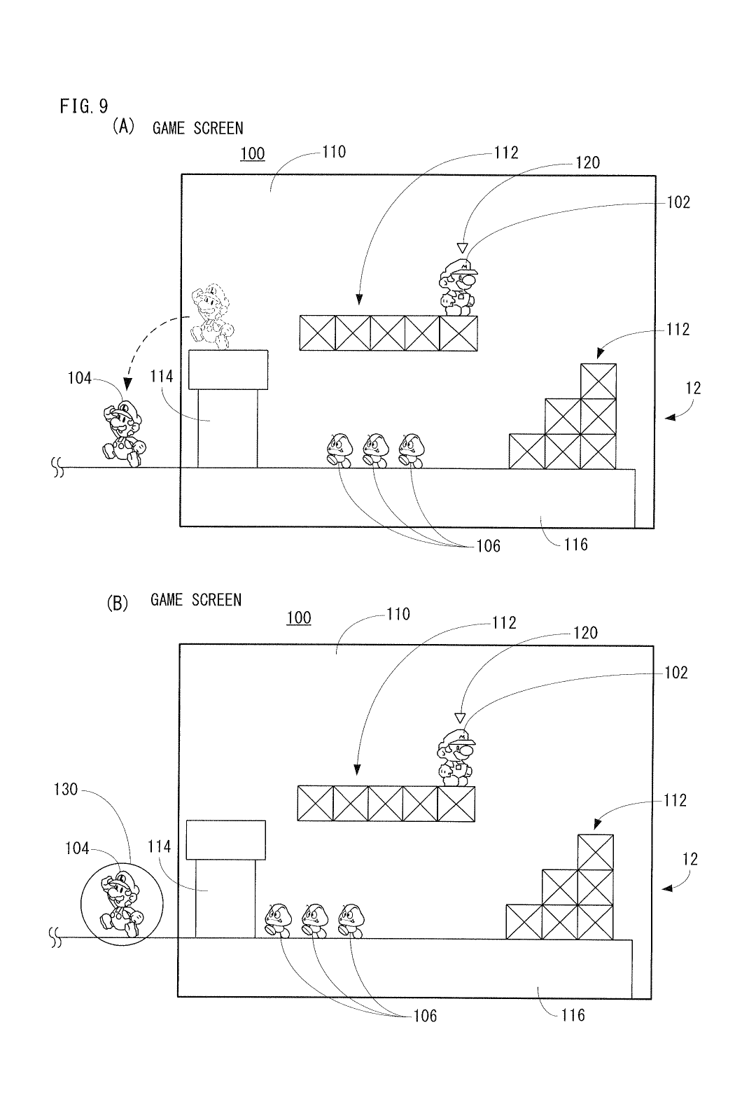

As shown in FIG. 9(A), for example, if the second player object 104 not having the scroll authorization goes out of the displaying range 220 and a time that the second player object 104 exists outside the displaying range 220 exceeds the predetermined time period, the second player object 104 is changed into the defensive state. In this embodiment, if the second player object 104 is changed to the defensive state, as shown in FIG. 9(B), the second player object 104 is covered by the soap-bubble object 130. That is, the second player object 104 is displayed inside the soap-bubble object 130.

In addition, a range defined by an outer frame by the game screen 100 is, off course, the displaying range 220.

Although a detailed description is omitted, in a case that the player object (102, 104) is changed into the defensive state by satisfying the first condition or the second condition, the transmogrification state of the player object (102, 104) is maintained. Therefore, if the defensive state is canceled, the player object (102, 104) returns to the last transmogrification state.

If the player object (102, 104) is changed to the defensive state, such the player object is moved to approach the player object (102, 104) not in the defensive state. In this embodiment, when the player object (102, 104) in the defensive state is returned into the displaying range 220, the player object (102, 104) is returned from a position that the player object (102, 104) went out the displaying range 220.

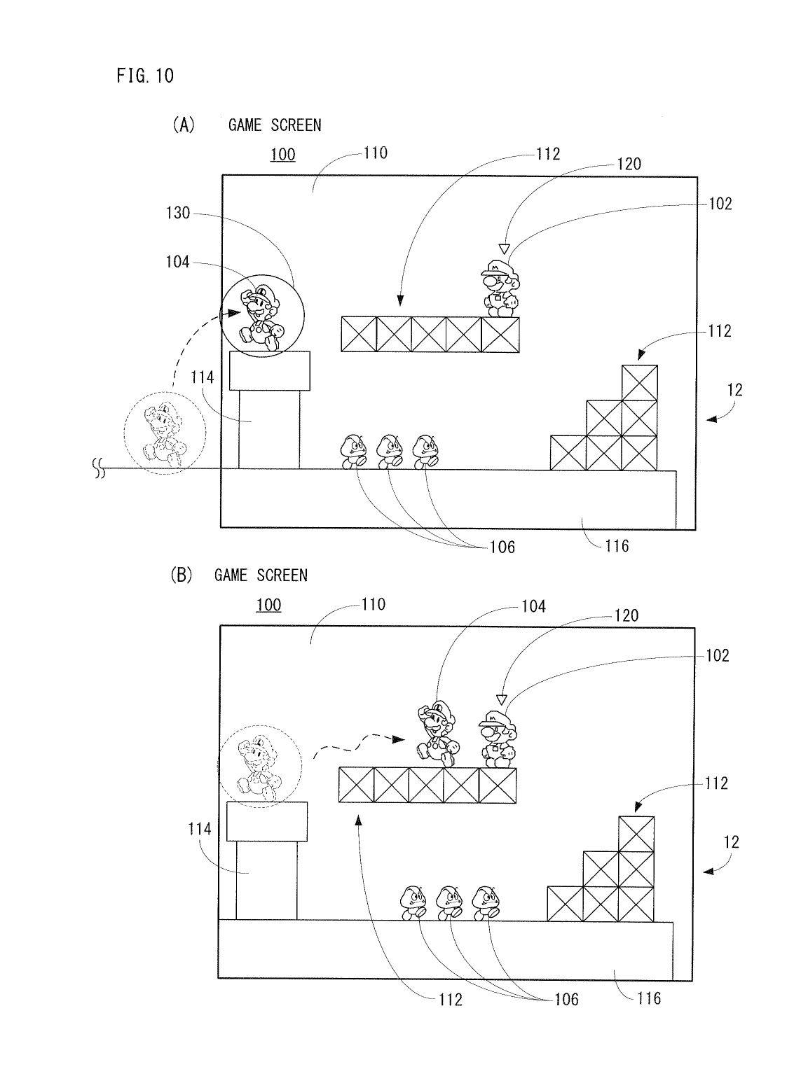

Therefore, as shown in FIG. 10(A), the second player object 104 of the defensive state is returned to the displaying range 220 to appear on an upper side of the pipe object 114. Then, the second player object 104 that is returned into the displaying range 220 and in the defensive state is moved to approach the first player object 102 not in the defensive state.

The player object (102, 104) of the defensive state only approaches the player object (102, 104) not in the defensive state, and therefore, the player object (102, 104) of the defensive state (strictly, the soap-bubble object 130) is not brought into contact with the player object (102, 104) not in the defensive state only by such a movement of a player object (102, 104) of the defensive state because as described later, in this embodiment, the defensive state of the player object (102, 104) is canceled by the player object (102, 104) not in the defensive state.

For example, within the displaying range 220, like as the soap-bubble object 130 flies lightly, the second player object 104 is moved together with the soap-bubble object 130; however, a manner of the movement is not limited thereto. The second player object 104 may be moved straight, or according to a path determined in random.

A reason why the player object (102, 104) in the defensive state is controlled to approach the player object (102, 104) not in the defensive state is that it is necessary for the player object in the defensive state to have its defensive state canceled by the player object not in the defensive state, and another reason is for making a less-skilled player to catch up with a high-skilled player even in a case that the players having different skills play the same virtual game. Furthermore, since the player object (102, 104) in the defensive state is moved to approach the player object (102, 104) not in the defensive state, that is, the player object (102, 104) having the scroll authorization, it is possible to move the defensive state player object to a position easy to see in the game screen 100.

Furthermore, in this embodiment, the defensive state of the player object (102, 104) in the defensive state is canceled based on an action of the player object (102, 104) not in the defensive state. For example, if the player object (102, 104) not in the defensive state breaks the soap-bubble object 130 covering the player object (102, 104) in the defensive state, the defensive state is canceled. When the player object (102, 104) not in the defensive state is brought into contact with the soap-bubble object 130 or when the shooting weapon (for example, an object of a fire ball) thrown by the player object (102, 104) not in the defensive state hits the soap-bubble object 130, the soap-bubble object 130 is broken.

Thus, by bringing the player object (102, 104) not in the defensive state into contact with the player object (102, 104) in the defensive state, it is possible to cancel the defensive state in the vicinity of the player object (102, 104) not in the defensive state itself. In a case that the shooting weapon is used, it is possible to cancel the defensive state from far away (even if it is far).

Therefore, the soap-bubble object 130 covering the player object (102, 104) in the defensive state is determined to come into collision with only the player object (102, 104) not in the defensive state or the object which is moved in response to an action by the player object (102, 104) not in the defensive state.

As shown in FIG. 10(B), for example, the second player object 104 in the defensive state flies lightly in a state that the same is covered by the soap-bubble object 130, and moves to approach the first player object 102 not in the defensive state. Then, if the first player object 102 is brought into contact with the soap-bubble object 130, the soap-bubble object 130 is broken, and thus, the defensive state of the second player object 104 is canceled.

As described above, there is an occasion that the player object (102, 104) is brought into the defensive state due to a failure or according to an operation of the player.

Briefly describing, if the player object (102, 104) is knocked-down by the enemy object 106 or fallen into a hole to go out of the course 210, the player object (102, 104) is determined to make a failure, and if the further player object (102, 104) does not make a failure, the player object (102, 104) is returned into the virtual game in the defensive state. If a failure occurs for the player object (102, 104), the player object (102, 104) disappears (is put out) from the virtual space, and in returning into the virtual game thereafter, the player object (102, 104) is produced in the default state so as to appear to the displaying range 220 from the center (may be not the center) at a side in the advancing direction of the virtual game (in this embodiment, the right end of the displaying range 220).

In addition, a reason why the player object (102, 104) appears at a side of the advancing direction of the virtual game in a case that a failure occurs is for showing the player that the player object (102, 104) is changed into the defensive state due to a failure.

A change to the defensive state of the player object (102, 104) due to a failure is only in a case that no failure occurs for the other player object (102, 104). Therefore, in a case that all other player objects (102, 104) are in the defensive state, for example, if a failure occurs for the player object (102, 104) not in the defensive state, such the player object (102, 104) is not changed into the defensive state, and the virtual game is continued from the starting position of the course 210 or the passing point of the course 210 with player objects (102, 104) being in the default state; however, if there is no remaining lives (the remaining lives are zero), the game becomes over.

Furthermore, if the player operates the touch panel 16 to instruct that the player object (102, 104) is to be changed into the defensive state, the concerned player object (102, 104) is brought into the defensive state at the current position while maintaining its transmogrification state. In addition, the player object (102, 104) may be changed to the defensive state by operating a predetermined button other than the touch panel 16.

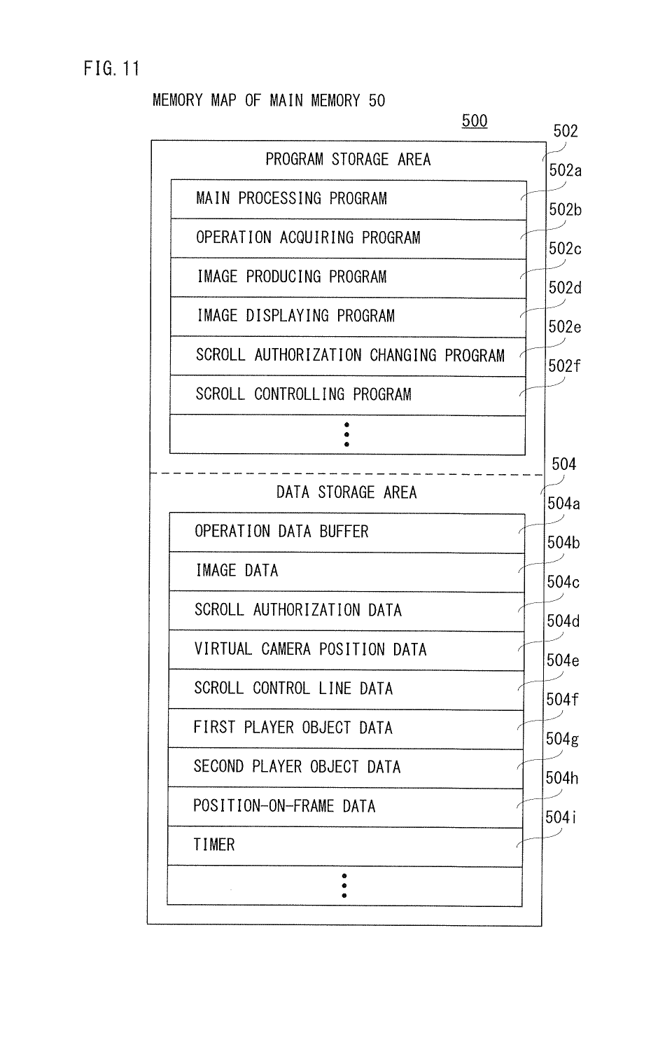

FIG. 11 is a view showing an example of a memory map 500 of the main memory 50 shown in FIG. 2. Although the memory map in a single game apparatus 10 is described here, a memory map in another game apparatus 10 which performs a communication game is similar to this.

As shown in FIG. 11, the main memory 50 includes a program storage area 502 and a data storage area 504. The program storage area 502 is stored with an information processing program such as a game program, and the information processing program includes a main processing program 502a, an operation acquiring program 502b, an image producing program 502c, an image displaying program 502d, a scroll authorization changing program 502e, a scroll controlling program 502f, etc.

The main processing program 502a is a program for processing a main routine of the virtual game in this embodiment. The operation acquiring program 502b is a program for receiving an operation input from each player and for acquiring an operation input (operation data) thus input. In this embodiment, the operation acquiring program 502b receives the operation data of the own game apparatus and the operation data of the other game apparatus which are used to play a communication game (a virtual game), and stores the operation data acquired through such a reception in an operation data buffer 504a described later.

The image producing program 502c is a program for producing an image (game image) for displaying the game screen 100 on the stereoscopic LCD 12 and/or displaying a screen on the lower LCD 14. The image producing program 502c draws (produces), with using image data 504b described later, various kinds of objects (102, 104, 106, 110, 112, 114, 120, 130, etc.) in the virtual space 200.

The image displaying program 502d is a program for displaying (outputting) an image produced by the image producing program 502c on the stereoscopic LCD 12 and the lower LCD 14. Therefore, screens such as the above-described game screen 100 and so on are displayed on the stereoscopic LCD 12 and the lower LCD 14.

The scroll authorization changing program 502e is a program for determining whether or not a predetermined condition is satisfied, and changing the player object (102, 104) to have the scroll authorization in a case that the predetermined condition is satisfied. The scroll controlling program 502f is a program for controlling a movement of a displaying range 220 (in fact, a virtual camera) being a part of the virtual space 200 that is displayed on the stereoscopic LCD 12 by the image displaying program 502d, and setting a movable range 230 in correspondence to the displaying range 220. In addition, since the movable range 230 is set in correspondence to the displaying range 220, it is possible to say that the scroll controlling program 502f controls a movement of the movable range 230.

Although not shown, the program storage area 502 is further stored with other programs such as a sound outputting program, a backing-up program, etc.

In the data storage area 504, an operation data buffer 504a is provided. The operation data buffer 504a is stored with the operation data of the own apparatus and the operation data of other apparatus being acquired in accordance with the operation acquiring program 502b. In the operation data buffer 504a, when the newest operation data is to be stored, the newest operation data is over-written on the previously stored operation data.

The data storage area 504 is further stored with image data 504b, scroll authorization data 504c, virtual camera position data 504d, scroll control line data 504e, first player object data 504f, second player object data 504g and position-on-frame data 504h.

The image data 504b includes data such as polygon data, texture data, etc., used in drawing (producing) an image by the image producing program 502c, and animation data for performing a predetermined action by the player object (102, 104) and the enemy object 106 and so on.

The scroll authorization data 504c is flag data for determining the player object (102, 104) having the scroll authorization. For example, the scroll authorization data 504c is constituted by a register having bits the number (“2” in this embodiment) of which is the same as the number of the player objects (102, 104) capable of simultaneously playing the communication game. Then, each bit corresponds to each player object (102, 104). When the player object (102, 104) has the scroll authorization, a data value “1” is set in the corresponding bit of the register, and if not have the scroll authorization, a data value “0” is set.

The virtual camera position data 504d is coordinates data of a position of the virtual camera in the virtual space 200. The displaying range 220 is determined in accordance with the position of the virtual camera, and a size of the displaying range 220 is determined by an angle of view of the virtual camera. The scroll control line data 504e are coordinates data respectively defining the scroll control lines 250-256 which are set in correspondence to the displaying range 220. As described above, since the displaying range 220 is determined in accordance with the position of the virtual camera, in fact, the scroll control line data 504e is set in correspondence to the virtual camera position data 504d.

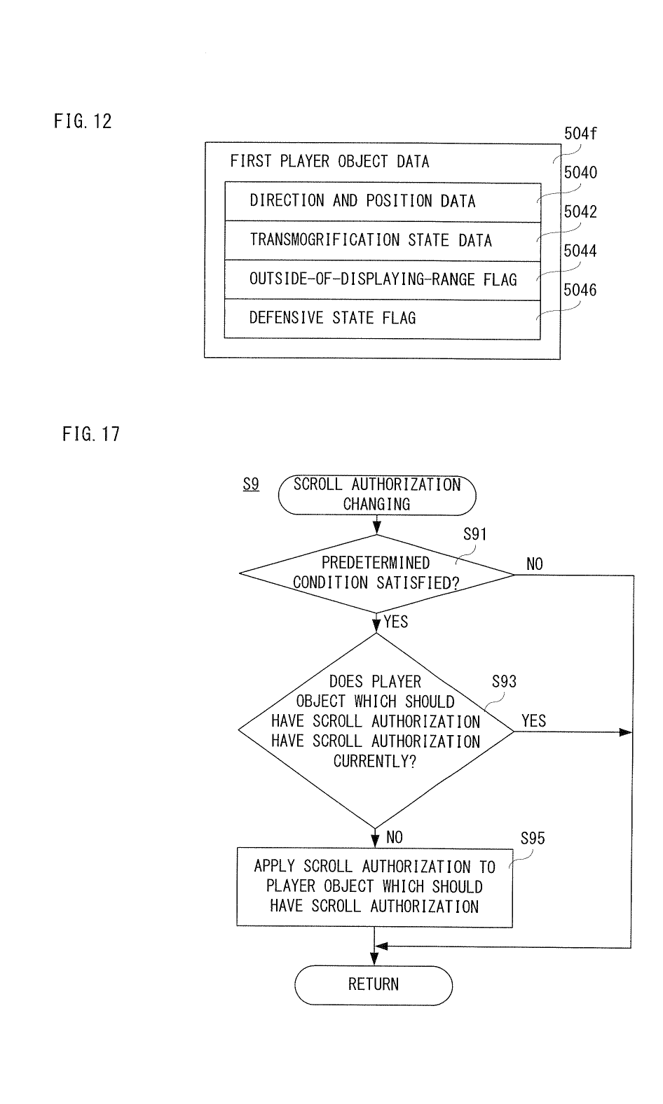

The first player object data 504f is data for the first player object 102. As shown in FIG. 12, the first player object data 504f includes direction and position data 5040, transmogrification state data 5042, an out-of-displaying-range flag 5044 and a defensive state flag 5046.

The direction and position data 5040 is data of a moving direction, a current position and a collision determining position of the first player object 102. In this embodiment shown, the moving direction is indicated by either one of left, right, top and bottom, and the current position and the collision determining position are represented by the coordinates. In addition, the collision determining position means X coordinate of a right end, X coordinate of a left end, Y coordinate of an upper end and Y coordinate of a lower end of the first player object 102 for determining whether or not the first player object 102 comes into contact (coincidence) with the scroll control lines 250-256 in scrolling the game screen 100.

The transmogrification state data 5042 is data representing the transmogrification state (including the default state) of the first player object 102. As described above, in this embodiment shown, the transmogrification state includes the default state, the smallest state, the enlarged state, the gigantic state, the state capable of using a shooting weapon, the state capable of flying and the invincible state. Therefore, the transmogrification state data 5042 is constructed by a 7-bit register, for example, and each bit corresponds to each state of the above-described states. In a state that the first player object 102 is able to fly, for example, a data value “1” is set in the corresponding bit, and a data value “0” is set in all other bits. In a case that the first player object 102 is in the enlarged state and the invincible state, a data value “1” is set in respective bits each corresponding to the enlarged state and the invincible state, and a data value “0” is set in all other bits. Although a description is omitted here, such a setting can be applied to other cases.

The out-of-displaying-range flag 5044 is a flag for determining whether or not the first player object 102 exists outside the displaying range 220, and constituted by one (1) bit register. In a case that the first player object 102 exists outside the displaying range 220, for example, the out-of-displaying-range flag 5044 is turned-on, and therefore, a data value“1” is set in the register. In a case that the first player object 102 exists inside the displaying range 220, the out-of-displaying-range flag 5044 is turned-off, and therefore, a data value“0” is set in the register.

The defensive state flag 5046 is a flag for determining whether or not the first player object 102 is in the defensive state, and constituted by one (1) bit register. If the first player object 102 is in the defensive state, for example, the defensive state flag 5046 is turned-on, and therefore, a data value“1” is set in the register. If the first player object 102 is not in the defensive state, the defensive state flag 5046 is turned-off, and therefore, a data value“0” is set in the register.

Returning to FIG. 11, the second player object data 504g is data for the second player object 104. As similar to the first player object 504f, the second player object data 504g includes direction and position data, transmogrification state data, an out-of-displaying-range flag and a defensive state flag, but a duplicate description is omitted here.

The position-on-frame data 504h is coordinates data for a position on a frame which defines the displaying range 220 at a time that the player object (102, 104) goes out of the displaying range 220. For example, a local coordinate system is set for the frame defining the displaying range 220, and coordinates data of the local coordinate system of a position where the player object (102, 104) passes when going out of the displaying range 220 is stored as the position-on-frame data 504h. The position-on-frame data 504h is stored for a reason that as described above, in a case that the player object (102, 104) becomes in the defensive state because the player object (102, 104) goes out of the displaying range 220, when the player object (102, 104) in the defensive state is to be returned within the displaying range 220, the player object (102, 104) is made to be returned from the position that the player object (102, 104) went out of the displaying range 220. Furthermore, the reason why the local coordinates of the frame of the displaying range 220 is stored is that if the displaying range 220 is moved, the above-described returning position is deviated.

Furthermore, the data storage area 504 is provided with a timer 504i which is for counting a time that the player object (102, 104) exists outside the displaying range 220.

As described above, in a case that three or more game apparatuses 10 are used, that is, the number of the players is three or more, it is necessary to provide timers the number of which is the number that “1” is subtracted from the total number of the players because it is necessary to individually count a time that a plurality of player objects each not having the scroll authorization exist outside the displaying range 220.

The data storage area 504 is further stored with other data necessary for executing the game program of the virtual game according to this embodiment, and provided with a further timer (counter) and a further flag.

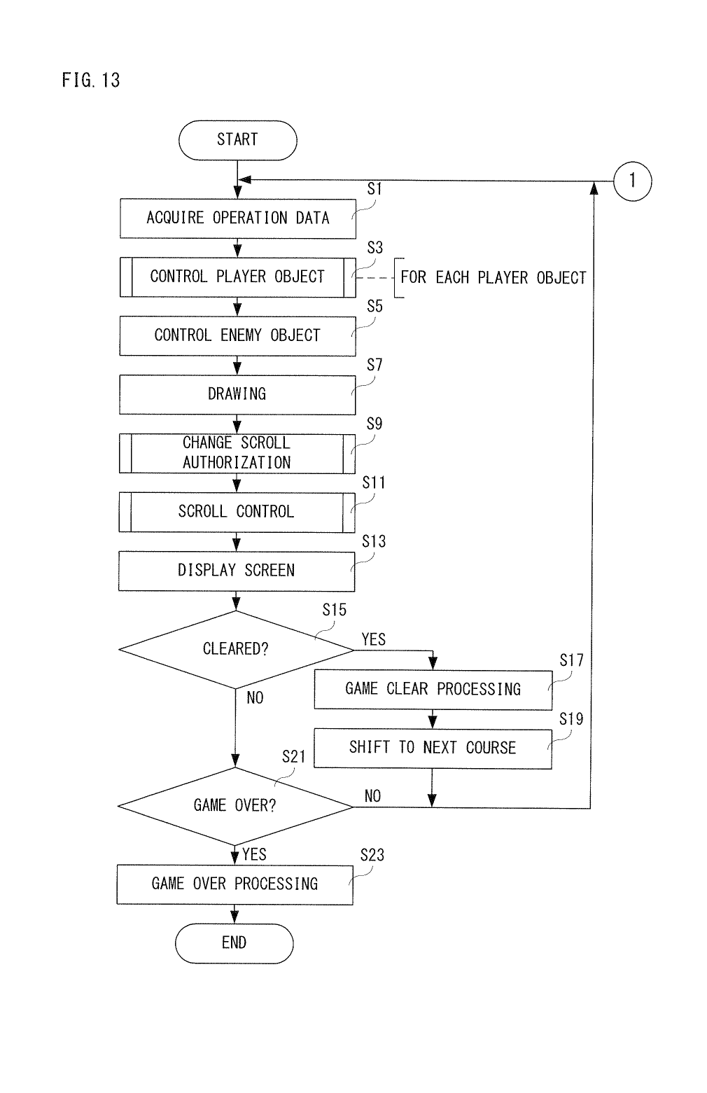

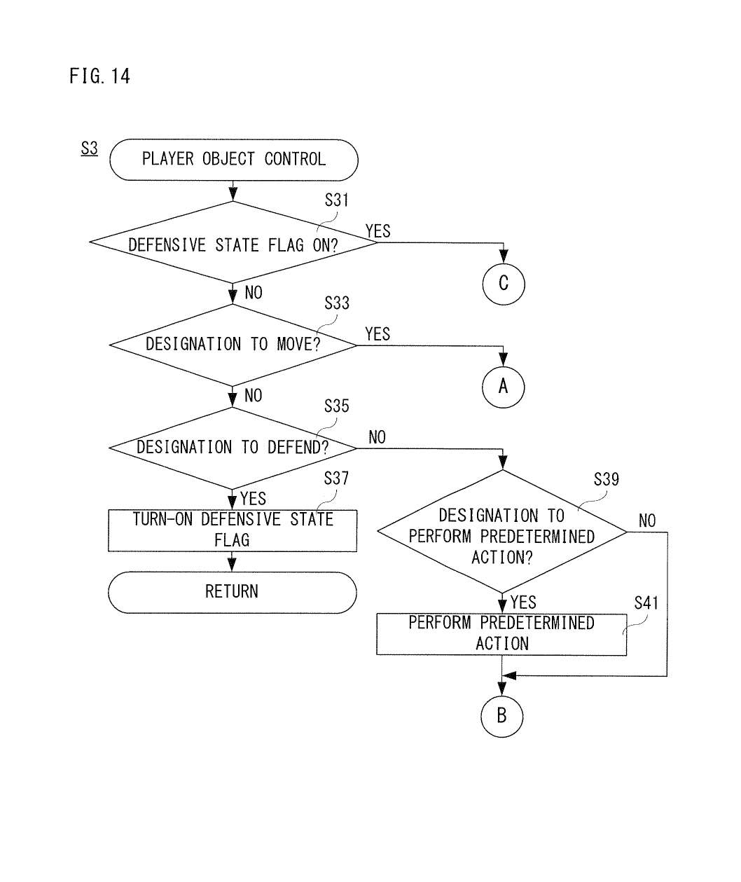

FIG. 13 is a flowchart showing a whole game process executed by the CPU 44a shown in FIG. 2 and FIG. 3. It is to be noted that this whole game process is executed in each game apparatus 10 playing the communication game. Although a detailed description is omitted here, among the game apparatuses 10, the operation data for each game apparatus 10 is synchronized with the operation data of the other game apparatus 10 by taking a time for communication, etc. into account. Here, processing in each step of the flowchart shown in FIG. 13 is mere examples (the same is true for FIG. 14-FIG. 20, described later), and an order or sequence of processing in respective steps is interchangeable as far as a similar result is obtained. Also, values of the variables and threshold values utilized in the determination steps are mere examples, and other values may be adopted as required. Furthermore, in this embodiment, a description will be made that the CPU 44a executes the processing in the respective steps of the flowchart shown in FIG. 13-FIG. 20; however, a processor and/or a dedicated circuit other than the CPU 44a may execute a part of the processing.

When the whole game processing is started as shown in FIG. 13, the CPU 44a acquires operation data in a step S1. Here, the CPU 44a receives operation inputs of the own apparatus and other apparatus to acquire operation data from the own apparatus and operation data from other apparatus, and stores them in the operation data buffer 504a; however, there is an occasion that the operation data of the own apparatus and/or other apparatus are/is not acquired.

In a next step S3, player object control processing (see FIG. 14-FIG. 16) described later is executed. In addition, the player object control processing is executed for the respective player objects (102, 104). Subsequently, in a step S5, enemy object control processing is executed. Here, the CPU 44a arranges (produces) the enemy object 106 in the virtual space 200, makes the enemy object 106 disappear according to the attack by the player object (102, 104), moves the enemy object 106, makes the enemy object 106 perform an arbitrary action, in accordance with the game program.

Subsequently, in a step S7, drawing processing is performed. Here, the CPU 44a and the GPU 44b draw the first player object 102, the second player object 104, the enemy object 106 and the background image 110 (including the background objects 112, 114 and 116), with using the image data 504b. At this time, in a case that the first player object 102 or the second player object 104 is in the defensive state (the defensive state flag (5046) thereof is turned-on), the soap-bubble object 130 is drawn so as to cover the player object (102, 104) in the defensive state.

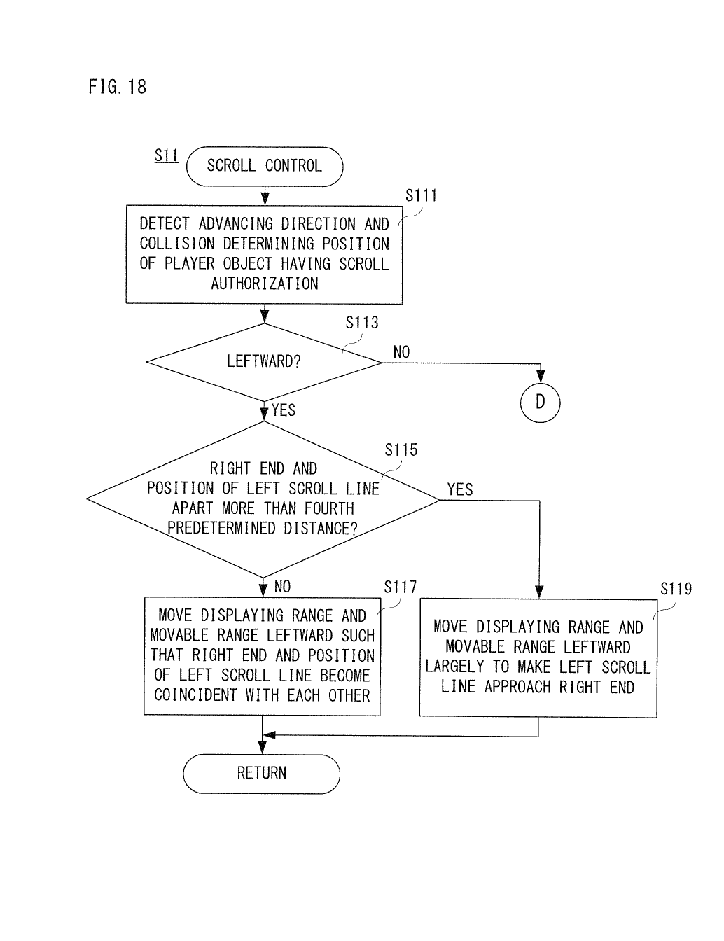

In a next step S9, scroll authorization changing processing (see FIG. 17) described later is performed, and in a step S11, scroll control processing (see FIG. 18-FIG. 20) described later is performed, and then, in a step S13, a screen displaying is performed. Here, an image imaged by the virtual camera in the virtual space 200, i.e., an image in the displaying range 220 is displayed on the stereoscopic LCD 12 as the game screen 100.

Next, in a step S15, it is determined whether or not the game is cleared. Here, the CPU 44a determines whether or not the game reaches the goal of the current course 210. If “YES” is determined in the step S15, that is, if the game is cleared, in a step S17, game clear processing is performed, wherein the CPU 44a displays the game screen 100 specially showing that the game is cleared (goal) and reproduces a sound (music) for dramatic effects. Thereafter, in a step S19, the game is moved to a next course 210, and then, returns to the step S1. In addition, if the last course 210 is cleared, the game is ended, and therefore, the whole game process is terminated.

On the other hand, if “NO” is determined in the step S15, that is, if the game is not cleared, in a step S21, it is determined whether or not the game becomes over. Here, the CPU 44a determines whether or not the remaining lives of the player object (102, 104) becomes zero (0), if “NO” is determined in the step S21, that is, the game does not become over, the process returns to the step S1. On the other hand, if “YES” is determined in the step S21, that is, the game becomes over, in a step S23, game over processing is performed, and thereafter, the whole game process is terminated. In the step S23, the CPU 44a displays the game screen 100 specially showing that the game becomes over and reproduces the sound (music) for dramatic effects.

FIG. 14-FIG. 16 show a flowchart showing player object control processing shown in the step S3 in FIG. 13. Here, the player object control processing for the first player object 102 will be described, but this is true for the second player object 104.

Although not shown, at a time of the start of the virtual game, the first player object 102 is arranged at a predetermined position in a predetermined moving direction (orientation), and coordinates data of the predetermined position and the collision determining position and data about the predetermined moving direction are stored in the data storage area 504 as the direction and position data 5040.

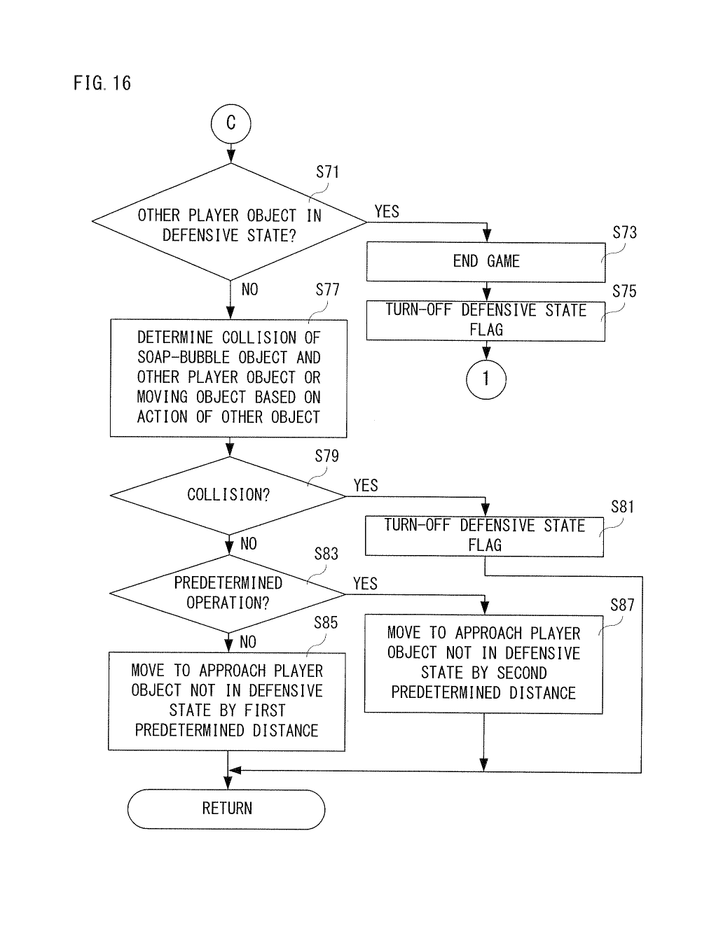

As shown in FIG. 14, if the player object control processing is started, the CPU 44a determines whether or not the defensive state flag 5046 is turned-on in a step S31. If “YES” is determined in the step S31, that is, if the defensive state flag 5046 is turned-on, the process proceeds to a step S71 shown in FIG. 16. On the other hand, if “NO” is determined in the step S31, that is, if the defensive state flag 5046 is turned-off, it is determined whether or not an instruction or designation of movement exists in a step S33. Here, the CPU 44a determine, with referring to the operation data buffer 504a, whether walking, running, ascending (going up) or descending (going down) is instructed or designated by the operation of a predetermined key or button such as the cross key 24g.

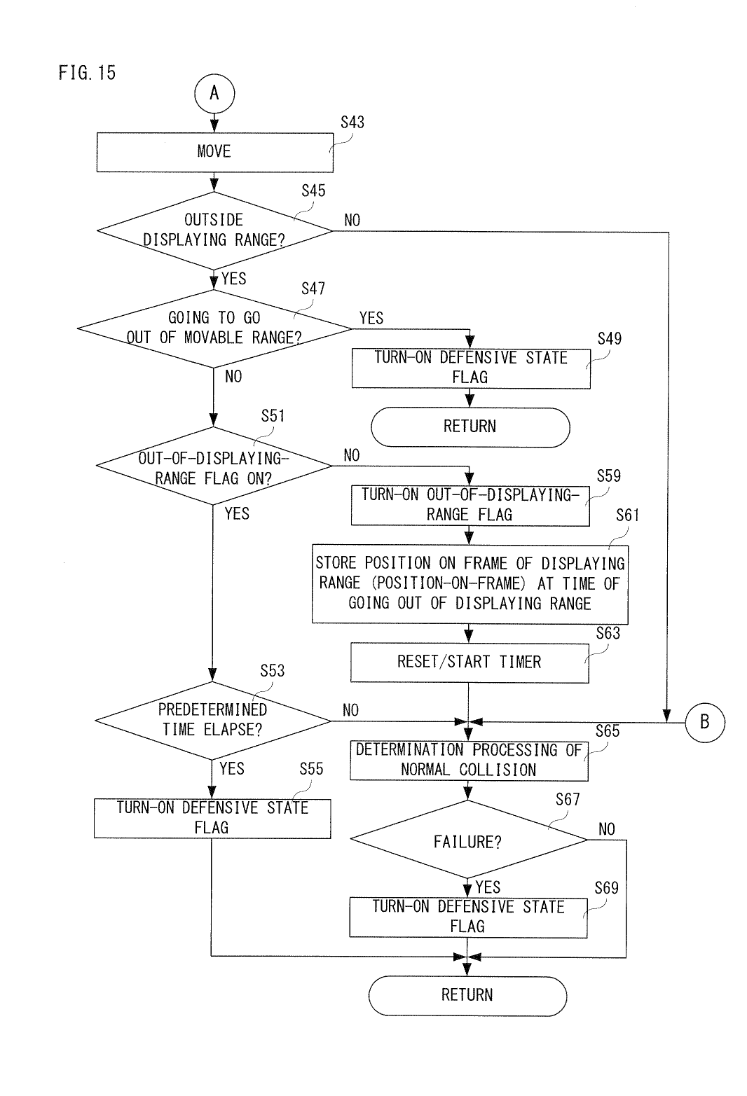

If “YES” is determined in the step S33, that is, if the designation of the movement exists, the process proceeds to a step S43 shown in FIG. 15. If “NO” is determined in the step S33, that is, there is no instruction of the movement, in a step S35, it is determined whether or not an instruction or designation of defense exists, wherein, the CPU 44a determines, with referring to the operation data buffer 504a, whether or not the player object 102 is instructed to be in the defensive state by operating the touch panel 16.

If “YES” is determined in the step S35, that is if there is a designation of the defense, in a step S37, the defensive state flag 5046 is turned-on, and then, the process returns to the whole game process. In a case that the player object 012 is brought into the defensive state by an operation by the player, in the whole game process, the first player object 102 is covered by the soap-bubble object 130 at the current position while the transmogrification state just before the defense designation is maintained.

If “NO” is determined in the step S35, that is, if no designation of defense exists, in a step S39, it is determined whether or not there is an instruction or designation for a predetermined action. Here, the CPU 44a determines, with referring to the operation data buffer 504a, a predetermined button (A, B, X and Y buttons 24a-24d, for example) is operated to perform the predetermined action.

If “NO” is determined in the step S39, that is, if there is no designation of the predetermined action, it is determined that no instruction or designation exists, and then, the process proceeds to a step S65 shown in FIG. 15. If “YES” is determined in the step S39, that is, if the instruction or designation for the predetermined action exists, in a step S41, the predetermined action of the first player object 102 designated is performed, and then, the process proceeds to the step S65. In this embodiment, according to the processing in the step S41, the first player object 102 jumps, flies, squats, performs the hip drop, punches, kicks or rotates (turns), for example.

As described above, if the movement instruction exists, “YES” is determined in the step S33, and therefore, as shown in FIG. 15, in the step S43, the first player object 102 moves. Here, the first player object 102 moves by a designated amount (speed) in the designated direction. Although not shown, at this time, the direction and position data 5040 is updated in accordance with the moving direction and the current position after moving. This is true for a case that the first player object 102 moves as described in the following.

In a next step S45, it is determined whether or not the first player object 102 exists outside the displaying range 220. In addition, the determination whether or not the first player object 102 goes out of the displaying range 220 is performed in accordance with a determination result of the collision determination between the first player object 102 and the frame (periphery) of the displaying range 220. In a case that the first player object 102 goes out of the displaying range 220, the out-of-displaying-range flag 5044 is turned-on. That is, in the step S45, the CPU 44a determines, based on whether or not the out-of-displaying-range flag 5044 is turned-on, whether or not the first player object 102 exists outside the displaying range 220. Furthermore, in the step S45, in a case that the out-of-displaying-range flag 5044 is turned-off, the CPU 44a performs the collision determination between the first player object 102 and the frame of the displaying range 220, and determines whether or not the first player object 102 goes out of the displaying range 220 based on such a determination result.

If “NO” is determined in the step S45, that is, if the first player object 102 exists within the displaying range 220, the process proceeds to the step S65. If “YES” is determined in the step S45, that is, if the first player object 102 exists outside the displaying range 220, in a step S47, it is determined whether or not the first player object 102 is going to go out of the movable range 230, wherein, the CPU 44a performs the collision determination between the first player object 102 and the frame (periphery) of the movable range 230. Then, if the first player object 102 and the frame of the movable range 230 collide with each other, the CPU 44a determines that the first player object 102 is going to go out of the movable range 230.

If “YES” is determined in the step S47, that is, if the first player object 102 is going to go out of the movable range 230, in a step S49, the defensive state flag 5046 is turned-on, and then the process returns to the whole game process. At this time, the transmogrification state of the first player object 102 is maintained. Therefore, in a case that the first player object 102 is going to go out of the movable range 230 and thus changed to the defensive state, in the whole game process, the first player object 102 is covered by the soap-bubble object 130 while maintaining the transmogrification state just before the change to the defensive state, and come into the displaying range 220 from a position that the first player object 102 went out of the displaying range 220. This is true for a case that the defensive state flag 5046 is turned-on in a step S55.

If “NO” is determined in the step S47, that is, if the first player object 102 is not going to go out of the movable range 230, in a step S51, it is determined whether or not the out-of-displaying-range flag 5044 is turned-on. If “YES” is determined in the step S51, that is, if the out-of-displaying-range flag 5044 is turned-on, in a step S53, it is determined whether or not a predetermined time period elapses. Here, the CPU 44a determines, with referring to a count value of the timer 504i, whether or not the predetermined time period (180 frames, for example) elapses. If “NO” is determined in the step S53, that is, if the predetermined time period does not elapse, the process proceeds to the step S65. If “YES” is determined in the step S53, that is, if the predetermined time period elapses, the defensive state flag 5046 is turned-on in the step S55, and then, the process returns to the whole game process.

Furthermore, if “NO” is determined in the step S51, that is, if the out-of-displaying-range flag 5044 is turned-off, it is determined that the first player object 102 goes out of the displaying range 220 at this time, and in a step S59, the out-of-displaying-range flag 5044 is turned-on, and then, in a step S61, the position on the frame of the displaying range 220 at a time that the first player object 102 went out of the displaying range 220 is stored. That is, the position-on-frame data 504h is stored in the data storage area 504. In a next step S63, the timer 504i is reset and started, and then, the process proceeds to the step S65.

In the step S65, normal collision determination processing is performed. Here, the collision of the first player object 102 with respect to the enemy object 106 and the background object (112, 114 and 116) is determined. In addition, within the enemy object 106, an object (moving object) that is moved according to the movement or action of the enemy object 106 is also included.

Then, in a step S67, it is determined whether or not a failure occurs. In a case that the first player object 102 is in the smallest state or the default state, for example, if and when the enemy object 106 or moving object collides at a part of the first player object 102 other than the predetermined part, a failure occurs. Furthermore, in a case that the first player object 102 goes out of the course 210, for example, irrespective of the size of the player object 102, a failure occurs. In this embodiment shown, since the first player object 102 is capable of stamping the enemy object 106 or performing the hip drop, the predetermined part is a foot or leg portion of the first player object 102 or a hip portion of the first player object 102 at a time that the hip drop.

If “NO” is determined in the step S67, that is, if a failure does not occur, the process returns to the whole game process. If “YES” is determined in the step S67, that is, if a failure occurs, in a step S69, the defensive state flag 5046 is turned-on, and then, the process returns to the whole game process. In a case that the first player object 102 is changed to the defensive state due to the failure, in the whole game process, the first player object 102 is covered by the soap-bubble object 130 in its default state, and comes into the displaying range 220 from the center of the front side (right side) of the displaying range 220.

As described above, in a case that the defensive state flag 5046 is turned-on, “YES” is determined in the step S31, and therefore, in a step S71 shown in FIG. 16, it is determined whether or not the other player object is in the defensive state. Here, the CPU 44a determines whether or not the defensive state flag for the second player object 104 is turned-on. If “YES” is determined in the step S71, that is, if the other player object is in the defensive state, in a step S73, the game is ended, and in a step S75, the defensive state flag 5046 is turned-off, and then, the process proceeds to the step S1 in FIG. 13 such that the game is started again at the start position of the current course 210 or the passing point of the current course 210. At this time, the transmogrification state of the player object 102 is maintained.

In addition, although a detailed description is omitted here, in a case that three or more players play the virtual game, in the step S71, it is determined whether or not all other player objects are in the defensive state, respectively.

If “NO” is determined in the step S71, that is, the other player object is not in the defensive state, in a step S77, a collision determination of the soap-bubble object 130 and the other player object or the moving object which is moved according to the movement or action of the other player object is performed, and then, in a step S79, it is determined whether or not the collision exists.

If “YES” is determined in the step S79, that is, if the collision exists, in a step S81, the defensive state flag 5046 is turned-off, and then, the process returns to the whole game process. Therefore, in the whole game process, the soap-bubble object 130 covering the first player object 102 is broken and thus disappears. Then, in a case that the first player object 102 is changed to the defensive state due to a failure, the first player object 102 returns in the virtual game that a normal collision determination is performed with being in the default state. In a case that the first player object 102 is brought into the defensive state in response to an operation by a player or in accordance with that the first player object 102 exists outside the displaying range 220 for a predetermined time period or more, or in accordance with that the first player object 102 is going to go out of the movable range 230, the first player object 102 returns (is undone) in the virtual game where a normal collision determination is performed while maintaining the transmogrification state just before a change to the defensive state.

If “NO” is determined in the step S79, that is, if no collision occurs, in a step S83, it is determined whether or not a predetermined operation exists. Here, the CPU 44a determines whether or not an operation for making the first player object 102 rapidly approach the other player object exists (L button or R button 24e or 24f is turned-on, for example).

If “NO” is determined in the step S83, that is, there is not the predetermined operation, in a step S85, the first player object 102 is moved so as to approach the player object not in the defensive state, i.e., the second player object 104 (also in a step S87) by a first predetermined distance, and then, the process returns to the whole game process. In the step S85, if the first player object 102 in the defensive state approaches the second player object 104 not in the defensive state up to a third predetermined distance, it is controlled that the first player object 102 cannot approach the other player object anymore. A reason is that the defensive state is prevented from being canceled because when the first player object 102 in the defensive state merely approaches the second player object 104 not in the defensive state, the soap-bubble object 130 is broken and thus the defensive state is cancelled. Therefore, the third predetermined distance is set as a distance that the soap-bubble object 130 is not brought into contact with the player object (102, 104) not in the defensive state. This is true for the step S87.

If “YES” is determined in the step S83, that is, there is the predetermined operation, in the step S 87, the first player object 102 is moved so as to approach the player object not in the defensive state by a second predetermined distance (longer than the first predetermined distance), and then, the process returns to the whole game process.

FIG. 17 is a flowchart of the scroll authorization changing processing of the step S9 shown in FIG. 13. If the scroll authorization changing processing is started, as shown in FIG. 17, the CPU 44a determines, in a step S91, whether or not a predetermined condition is satisfied. The predetermined conditions are as described above and the CPU 44a determines whether or not any one of such predetermined conditions is satisfied.

If “NO” is determined in the step S91, that is, if the predetermined condition is not satisfied, the process returns to the whole game process. If “YES” is determined in the step S91, that is, if the predetermined condition is satisfied, in a step S93, it is determined whether or not the player object (102, 104) who should have the scroll authorization has the scroll authorization currently. In a case that the scene is changed, for example, as described above, the player object (102, 104) who firstly performs an action which causes the scene to be changed is the player object (102, 104) who should have the scroll authorization. Here, the CPU 44a determines, with referring to the scroll authorization data 504c, the player object (102, 104) having the scroll authorization currently is the player object (102, 104) who should have the scroll authorization.

If “YES” is determined in the step S93, that is, if the player object (102, 104) who should have the scroll authorization has the scroll authorization currently, it is not necessary to change the scroll authorization, and therefore, the process returns to the whole game process. If “NO” is determined in the step S93, that is, if the player object (102, 104) who should have the scroll authorization does not have the scroll authorization currently, it is determined that the scroll authorization is to be moved, and in a step S95, the scroll authorization is set for the player object (102, 104) who should have the scroll authorization, and then, the process returns to the whole game process. Accordingly, in a case that the scroll authorization is transferred, in the whole game process, the designating image 120 is displayed above the player object (102, 104) having the scroll authorization being moved.

FIG. 18 to FIG. 20 show a flowchart of scroll control processing of the step S11 shown in FIG. 13. As shown in FIG. 18, if the scroll control processing is started, the CPU 44a detects the advancing direction and the collision determination position of the player object having the scroll authorization (hereinafter, called as “the concerned player object”) in a step S111. Here, the CPU 44a detects the advancing direction and the collision determining position (the X coordinate at the right end and the left end, and the Y coordinate at the upper end and the lower end) of the concerned player object, with referring to the direction of the player object data and the position data 5040 for the concerned player object.

In a next step S113, it is determined whether or not the advancing direction is a leftward direction. If “YES” is determined in the step S113, that is, if the advancing direction is the leftward direction, in the step S115, it is determined whether or not the right end of the concerned player object is separated from the position of the left scroll line (scroll control line 252) by a fourth predetermined distance or more. Here, the fourth predetermined distance is a distance for moving the displaying range 220 and the movable range 230 at a speed faster than a moving speed of the concerned player object (102, 104) as in a case that the player object (102, 104) having the scroll authorization changes the moving direction thereof. The fourth predetermined distance is set in advance. In a step S115, the CPU 44a detects, with referring to the scroll control line data 504e, the X coordinate defining the position of the scroll control line 252, and determines whether or not the detected X coordinate is separated from the X coordinate at the right end of the concerned player object by the fourth predetermined distance or more.

If “NO” is determined in the step S115, that is, a distance between the right end of the concerned player object and the position of the left scroll line is less than the fourth predetermined distance, in a step S117, the displaying range 220 and the movable range 230 are moved in the leftward direction such that the right end of the concerned player object and the position of the left scroll line become coincident with each other, and then, the process returns to the whole game process. That is, the game screen 100 is scrolled in the leftward direction in accordance with the movement of the concerned player object. However, if the concerned player object is not moved, processing in the step S117 is not performed. This is true for the steps S125, S133 and S139.

If “YES” is determined in the step S115, that is, if the right end of the concerned player object and the position of the left scroll line are separated from each other by the fourth predetermined distance or more, in a step S119, the displaying range 220 and the movable range 230 are largely moved in the leftward direction such that the position of the left scroll line is approached to the right end of the concerned player object, and then, the process returns to the whole game process. Here, the game screen 100 is scrolled in the leftward direction at the speed faster than the moving speed of the concerned player object. A distance for largely moving the displaying range 220 and the movable range 230 in the leftward direction may be set in advance or calculated according to the speed of the concerned player object. This is true for steps S127, S135 and S141.

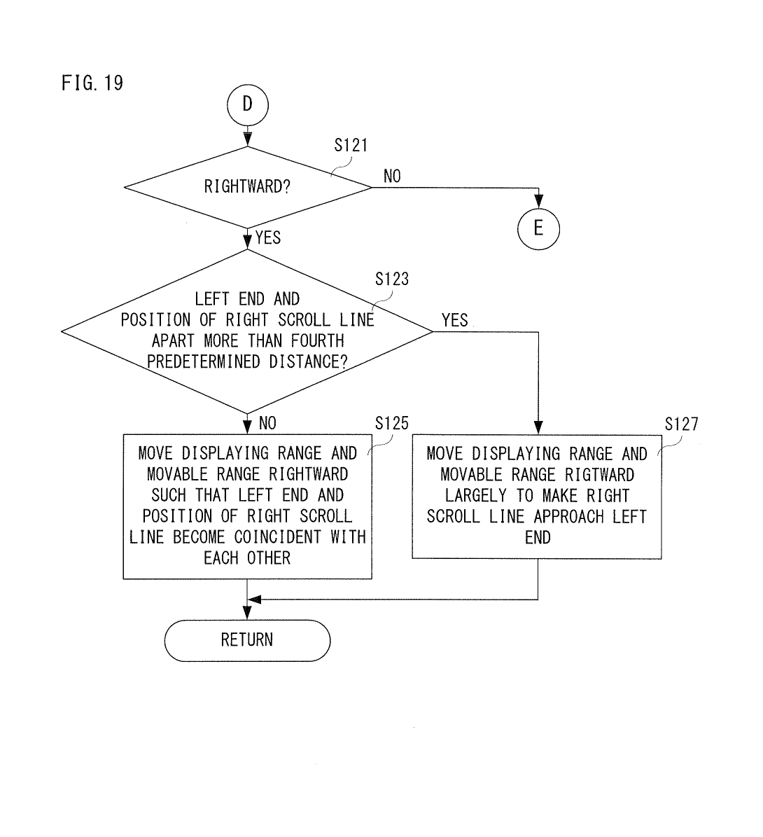

If “NO” is determined in the step S113, that is, if the advancing direction is not the leftward direction, in a step S121 shown in FIG. 19, it is determined whether or not the advancing direction is the rightward direction. If “YES” is determined in the step S121, that is, if the advancing direction is the rightward direction, in a step S123, it is determined whether or not the left end of the concerned player object and the position of the right scroll line (scroll control line 250) are separate from each other by the fourth predetermined distance or more. Here, the CPU 44a detects, with referring to the scroll control line data 504e, the X coordinate defining the position of the scroll control line 250, and determines whether or not the detected X coordinate is separated from the X coordinate at the left end of the concerned player object by the fourth predetermined distance or more.

If “NO” is determined in the step S123, that is, if a distance between the left end of the concerned player object and the position on the right scroll line is less than the fourth predetermined distance, in a step S125, the displaying range 220 and the movable range 230 are moved in the rightward direction such that the left end of the concerned player object and the position of the right scroll line become coincident with each other, and then, the process proceeds to the whole game process. That is, the game screen 100 is scrolled in the rightward direction according to the movement of the concerned player object.

If “YES” is determined in the step S123, that is, if the left end of the concerned player object and the position of the right scroll line are separated from each other by the fourth predetermined distance or more, in a step S127, the displaying range 220 and the movable range 230 are largely moved in the rightward direction such that the position of the right scroll line is approached to the left end of the concerned player object, and then, the process returns to the whole game process. Here, the game screen 100 is scrolled in the rightward direction at the speed faster than the moving speed of the concerned player object.

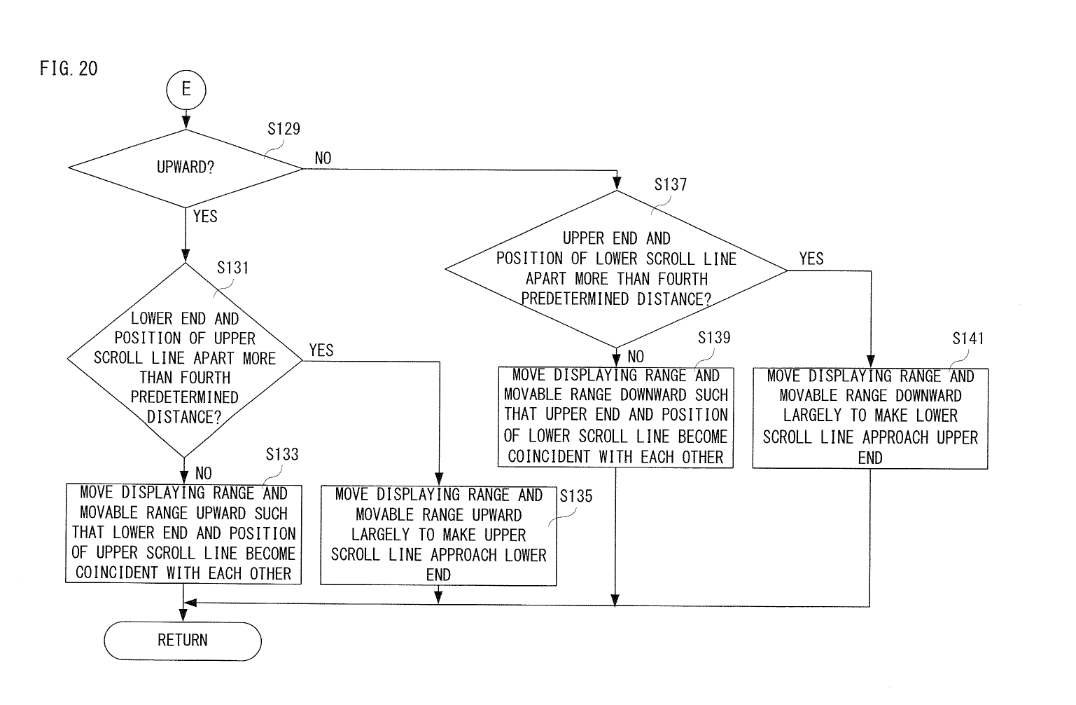

If “NO” is determined in the step S121, that is, if the advancing direction is not the rightward direction, in a step S129 shown in FIG. 20, it is determined whether or not the advancing direction is the upward direction. If “YES” is determined in the step S129, that is, if the advancing direction is the upward direction, in a step S131, it is determined whether or not the lower end of the concerned player object and the position of the top scroll line (scroll control line 256) are separate from each other by the fourth predetermined distance or more. Here, the CPU 44a detects, with referring to the scroll control line data 504e, the Y coordinate defining the position of the scroll control line 256, and determines whether or not the detected Y coordinate is separated from the Y coordinate at the lower end of the concerned player object by the fourth predetermined distance or more.

If “NO” is determined in the step S131, that is, if a distance between the lower end of the concerned player object and the position on the top scroll line is less than the fourth predetermined distance, in a step S133, the displaying range 220 and the movable range 230 are moved in the upward direction such that the lower end of the concerned player object and the position of the top scroll line become coincident with each other, and then, the process proceeds to the whole game process. That is, the game screen 100 is scrolled in the upward direction according to the movement of the concerned player object.

If “YES” is determined in the step S131, that is, if the lower end of the concerned player object and the position of the top scroll line are separated from each other by the fourth predetermined distance or more, in a step S135, the displaying range 220 and the movable range 230 are largely moved in the upward direction such that the position of the right scroll line is approached to the lower end of the concerned player object, and then, the process returns to the whole game process. Here, the game screen 100 is scrolled in the upward direction at the speed faster than the moving speed of the concerned player object.

If “NO” is determined in the step S129, that is, if the advancing direction is the downward direction, in a step S137, it is determined whether or not the upper end of the concerned player object and the position of the lower scroll line (scroll control line 254) are separate from each other by the fourth predetermined distance or more. Here, the CPU 44a detects, with referring to the scroll control line data 504e, the Y coordinate defining the position of the scroll control line 254, and determines whether or not the detected Y coordinate is separated from the Y coordinate at the upper end of the concerned player object by the fourth predetermined distance or more.

If “NO” is determined in the step S137, that is, if a distance between the upper end of the concerned player object and the position on the lower scroll line is less than the fourth predetermined distance, in a step S139, the displaying range 220 and the movable range 230 are moved in the downward direction such that the upper end of the concerned player object and the position of the bottom scroll line become coincident with each other, and then, the process proceeds to the whole game process. That is, the game screen 100 is scrolled in the downward direction according to the movement of the concerned player object.

If “YES” is determined in the step S137, that is, if the upper end of the concerned player object and the position of the lower scroll line are separated from each other by the fourth predetermined distance or more, in a step S141, the displaying range 220 and the movable range 230 are largely moved in the downward direction such that the position of the lower scroll line is approached to the upper end of the concerned player object, and then, the process returns to the whole game process. Here, the game screen 100 is scrolled in the downward direction at the speed faster than the moving speed of the concerned player object.

In addition, in this embodiment shown, the fourth predetermined distance in each of the steps S115, S123, S131 and S137 may be the same value, or may be different from each other partly or wholly.

According to this embodiment, if the player object goes out of the displaying range, the player object is changed into the defensive state, and in such a defensive state, the player object is not affected by the attack by the enemy object. Therefore, since the player object can approach the other player object not in the defensive state while securing the safety, even when the player object of a poor-skilled player delays the player object of a high-skilled player, it is possible to approach the player object of a poor-skilled player to the player object of a high-skilled player. Therefore, it is possible to enjoy the same game together even if the players have different abilities.

Furthermore, in this embodiment, since the scroll authorization applied to the player object or the player is changed if the predetermined condition is satisfied, it is possible to prevent only one player object or player from having fixedly the scroll authorization, and therefore, respective players are provided with an equal chance for moving the displaying range. Therefore, it is possible to display a plurality of player objects in a single display screen without impairing operation feeling of each player.

Furthermore, according to this embodiment, the predetermined condition for moving the scroll authorization can be satisfied based on the operation by the player, that is, such the predetermined condition is not related to the progress of the game and the ability of the player, and accordingly, since the displaying range is not moved only according to the operation by the player having high ability, it is possible for the players having poor ability and the player having good ability to enjoy the game together.

Furthermore, in this embodiment, since the movable range wider than the displaying range is set, even when a poor-skilled player delays a high-skilled player, the players can take some extra time for operating the game, whereby a failure by the player object being sandwiched between the displaying range and the background object, for example can be prevented.

In addition, in this embodiment, in order to identify the player object in the defensive state and the player object not in the defensive state from each other, the player object is displayed with being covered by the soap-bubble object, but not limited thereto. For example, the player object in the defensive state may be displayed semi-transparently, or may be blinkingly displayed, or may be displayed in a color different from a color of the player object not in the defensive state.

In this embodiment, the player object in the defensive state is moved to approach the player object not in the defensive state, but limited thereto. The player object in the defensive state may be moved toward the center of the displaying range, or the player object in the defensive state may be moved to approach a specific object other than the other player object.

In this embodiment, a description is made on a case that the communication game is performed with two game apparatuses (two players), but the communication game may be performed with three or more game apparatuses. In such a case, only one player object or player has the scroll authorization, and by satisfying the predetermined condition, the scroll authorization may be moved to another player object (player).

In this embodiment shown, although the player object is changed into the defensive state if the player object exists outside the displaying range for the predetermined time period or more or if the player object is going to go out of the movable range wider than the displaying range, by making the movable range and the displaying range coincident with each other, the player object may be changed to the defensive state when the player object is going to go out of the displaying range.

Furthermore, in this embodiment, the player object in the defensive state is moved toward the player object having the scroll authorization, but not limited thereto. In a case that three or more player objects exist, irrespective of the presence or absence of the scroll authorization, the player object in the defensive state may be moved toward the player object not in the defensive state, or irrespective of the state of other player objects, the player object in the defensive state may be moved toward the center of the displaying range (game screen).

Furthermore, in this embodiment, although a description is made on a case that the two-dimensional game screen is displayed, this embodiment can be applied to a case that the three-dimensional game screen is displayed because only the method for setting the movable range against the displaying range is different from a method in a case of the two-dimensional game screen.

The structure of the game apparatus is not limited to the structure of the game apparatus shown in the embodiment. For example, the touch panel may not be provided. The stereoscopic LCD may not be used. The touch panel may be provided on each of the two LCDs. The game apparatus may be a desk-top type or console type game apparatus for which a display device or monitor is provided separately. The game apparatus may be constructed as a game system in which a plurality of computers each executing a part of the process are connected with each other in a communicable manner.

Furthermore, in this embodiment, a description is made on a case that the communication game is played with using a plurality of game apparatuses each having a display integrally, but the embodiment can be applied to a case that the communication game is played by a plurality of players (persons) with using a desk-top type or console type game apparatus and separate display device or monitor.

While certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. A non-transitory computer readable storage medium storing a game program which is executable by a computer of a game apparatus in which each of a plurality of player objects moves within a first range in a virtual space according to an operation by each of a plurality of players, and a game screen based on a second range that is at least a part of the first range is displayed, wherein the game program causes the computer to function as:
an operation receiving portion which receives operating inputs from the plurality of players;
an object controlling portion which moves respective player objects each assigned to each of the plurality of players within the first range in accordance with the operating inputs received by the operation receiving portion;
a changing portion which changes, when a player object moved in accordance with an operating input by a player out of the plurality of players moves out of the second range, the player object into a defensive state defending the player object against an attack from an enemy object;
a defensive object moving portion which moves the player object changed to the defensive state within at least the second range; and
a returning portion which returns the player object changed to the defensive state to a state being not defended.

2. A non-transitory computer readable storage medium according to claim 1, wherein the changing portion changes, if and when a time period that the player object exists outside the second range reaches a predetermined time period, the player object into the defensive state.

3. A non-transitory computer readable storage medium according to claim 1, wherein the first range is a predetermined range that the player object is movable, and the second range is a displaying range narrower than the predetermined range.

4. A non-transitory computer readable storage medium according to claim 3, wherein the changing portion changes, if and when the player object is going to go out of the predetermined range, the player object into the defensive state.

5. A non-transitory computer readable storage medium according to claim 1, wherein the defensive object moving portion moves the player object in the defensive state within at least the second range irrespective of the operating input received by the operation receiving portion.

6. A non-transitory computer readable storage medium according to claim 1, wherein the returning portion returns the player object changed into the defensive state to the state being not defended after the player object is moved from outside the second range to within the second range by the defensive object moving portion.

7. A non-transitory computer readable storage medium according to claim 1, wherein the returning portion returns the player object in the defensive state to the state being not defended based on an action of the player object not in the defensive state.

8. A non-transitory computer readable storage medium according to claim 7, wherein the returning portion returns, if and when the player object not in the defensive state is brought into contact to the player object in the defensive state, the player object in the defensive state to the state not being defended.

9. A non-transitory computer readable storage medium according to claim 7, wherein the returning portion returns, if and when a moving object which is moved based on an action of the player object not in the defensive state is brought into contact with the player object in the defensive state, the player object in the defensive state to the state not being defended.

10. A non-transitory computer readable storage medium according to claim 1, wherein the game program further causes the computer as an object displaying portion which displays the player object in the defensive state from the player object not in the defensive state in an identifiable manner.

11. A non-transitory computer readable storage medium according to claim 10, wherein the object displaying portion displays the player object in the defensive state inside a predetermined object.

12. A non-transitory computer readable storage medium according to claim 5, wherein the defensive object moving portion moves the player object in the defensive state within the second range from a position that the player object went out of the second range.

13. A non-transitory computer readable storage medium according to claim 5, wherein the defensive object moving portion moves the player object in the defensive state to a center of the second range.

14. A non-transitory computer readable storage medium according to claim 5, wherein the defensive object moving portion moves the player object in the defensive state so as to approach a specific player object not in the defensive state out of the plurality of player objects.

15. A non-transitory computer readable storage medium according to claim 14, wherein the game program further causes the computer as a range moving portion which moves the second range in accordance with the position of the specific player object.

16. A non-transitory computer readable storage medium according to claim 1, wherein the first range has a shape obtained by analogously enlarging the second range.

17. A game apparatus which each of a plurality of player objects moves within a first range in a virtual space according to an operation by each of a plurality of players, and a game screen based on a second range that is at least a part of the first range is displayed, comprising:
an operation receiving portion which receives operating inputs from the plurality of players;
an object controlling portion which moves respective player objects each assigned to each of the plurality of players within the first range in accordance with the operating inputs received by the operation receiving portion;
a changing portion which changes, when a player object moved in accordance with an operating input by a player out of the plurality of players moves out of the second range, the player object into a defensive state defending the player object against an attack from an enemy object;
a defensive object moving portion which moves the player object changed to the defensive state within at least the second range; and
a returning portion which returns the player object changed to the defensive state to a state being not defended.

18. A game controlling method for a computer in which each of a plurality of player objects moves within a first range in a virtual space according to an operation by each of a plurality of players, and a game screen based on a second range that is at least a part of the first range is displayed, wherein the computer performing:
(a) receiving operating inputs from the plurality of players;
(b) moving respective player objects each assigned to each of the plurality of players within the first range in accordance with the operating inputs received in the step (a);
(c) changing, when a player object moved in accordance with an operating input by a player out of the plurality of players moves out of the second range, the player object into a defensive state defending the player object against an attack from an enemy object;
(d) moving the player object changed to the defensive state within at least the second range; and
(e) returning the player object changed to the defensive state to a state being not defended.

19. A game system in which each of a plurality of player objects moves within a first range in a virtual space according to an operation by each of a plurality of players, and a game screen based on a second range that is at least a part of the first range is displayed, comprising:
an operation receiving portion which receives operating inputs from the plurality of players;
an object controlling portion which moves respective player objects each assigned to each of the plurality of players within the first range in accordance with the operating inputs received by the operation receiving portion;
a changing portion which changes, when a player object moved in accordance with an operating input by a player out of the plurality of players moves out of the second range, the player object into a defensive state defending the player object against an attack from an enemy object;
a defensive object moving portion which moves the player object changed to the defensive state within at least the second range; and
a returning portion which returns the player object changed to the defensive state to a state being not defended.
